(19) United States
(12) Patent Application Publication
(10) Pub. No.: US 2009/0132349 A1
(43) Pub. Date: May 21, 2009

(54) Targeted-demographic rich-media content, branding, and syndicated user-node distribution

(75) Inventors: Michael Berkley, Portland, OR (US); Kim Ramage, Portland, OR (US); Frank Henderson, Portland, OR (US); Mark Richmond, Portland, OR (US)

Correspondence Address: ATER WYNNE LLP, 1331 NW Lovejoy St. Suite 900, PORTLAND, OR, 97209-2785, US

(73) Assignee: SplashCast Corp.

(21) Appl. No.: 12/286,761

(22) Filed: Oct. 1, 2008

Related U.S. Application Data
(63) Continuation-in-part of application No. 11/724,692, filed on Mar. 14, 2007.
(60) Provisional application No. 60/850,714, filed on Oct. 9, 2006.

(51) Int. Cl. G06Q 30/00; G06F 15/16; G06Q 10/00

(52) U.S. Cl. 705/10; 709/219; 705/14

(57) ABSTRACT

A rich-media content and branding method and system enable interactive creation of an exciting environment in which branded advertising subtly influences consumers who are enjoying a high-quality, entertaining, rich-media experience. Embedded rich-media players are bordered by branding information such as identification of source and e-mail click-on buttons to facilitate communications between sponsors and consumers, contributions by consumers to the sponsors' digital storehouse, and to facilitate viral exposure of content and brands to prospective consumers through on-line social interaction and networking at widely distributed and varietal user nodes, e.g. cell phones, PDAs, notebook computers, desktop computers, television (TV) set-top adapters, etc.

### RELATED APPLICATIONS

The present application claims priority to U.S. Provisional Patent Application Ser. No. 60/850,714, entitled MULTIMEDIA CONTENT PRODUCTION AND PUBLICATION SYSTEM AND METHOD and filed 9 Oct. 2006, and to U.S. patent application Ser. No. 11/724,692, entitled MULTIMEDIA CONTENT PRODUCTION, PUBLICATION, CHANNEL, AND PLAYER APPARATUS, SYSTEM AND METHOD and filed 14 Mar. 2007, the disclosures of which are incorporated herein in their entirety by this reference.

### BACKGROUND OF THE INVENTION

This invention relates generally to the field of website content production and distribution.

### BRIEF DESCRIPTION OF THE DRAWINGS

FIG. 1 is a schematic system block diagram that illustrates the invented Dynamic Media system architecture including the Dynamic Media Player in accordance with one embodiment of the invention.

FIG. 2 is a schematic block diagram of the Dynamic Media Model Player that forms a part of the system architecture in accordance with one embodiment of the invention.

FIG. 3 is a schematic block diagram that illustrates the invented viral adoption model in accordance with one embodiment of the invention.

FIG. 4 is a schematic functional block diagram that illustrates the invented Manager that forms a part of the system architecture in accordance with one embodiment of the invention.

FIG. 5 is an illustration of the look and feel and ease-of-use of the invented system to produce and publish rich-media content.

FIG. 6 illustrates how a rich-media Feed or Channel is produced, in accordance with the invented system.

FIG. 7 illustrates how the Web 2.0 technologies enable different social networking and user-created media and thus create an opportunity for rich-media syndication in accordance with the invention.

FIG. 8 illustrates operation of a Player Wizard that is a part of the invented system to produce a simple but rich-media Feed.

FIG. 9 lists examples of what can be produced, syndicated and published with the invented system.

FIG. 10 illustrates how private, public and commercial assets are centrally managed for compliance with the copyright laws.

FIGS. 11A-11H illustrate the Dynamic Media Model Player's translucent skin rendered visible by “mousing over” the window region of a webpage having the Dynamic Media Model Player of FIG. 2 embedded therein. Specifically, FIGS. 11A-11H illustrate a tutorial that illustrates various aspects of the use of the Player Console to Add an Item to a Show (FIG. 11A), Search a database, e.g. Flickr™, for photos to include therein (FIG. 11B), produce a Show by swapping or re-sequencing the Items within the Show (FIG. 11C), view Show Information including Properties (FIG. 11D), add Background Audio to a Show (FIG. 11E), Publish a Show (FIG. 11F), Select a Channel to which to assign the Show (FIG. 11G), and Publish the Show to a Player (FIG. 11H), all in accordance with the web-based, syndicated player apparatus, system and distribution methods of the invention.

FIG. 12 is a schematic block diagram that illustrates one possible Monetization Hierarchy or structure that may form a part of the system architecture in accordance with one embodiment of the invention.

FIG. 13 illustrates three different Syndication Finance Models that may be used in combination in accordance with one embodiment of the invention.

FIGS. 14A-14J illustrate the Targeted-Demographic Rich-Media Content and Branding system in screen-grab form, in accordance with another embodiment of the invention. Specifically, FIG. 14A illustrates a branded rich-media content player and its exemplary attributes. FIG. 14B illustrates the player embedded in a social networking website. FIG. 14C illustrates some of the features of the player and its associated channels that permit users to interact with a brand owner or sponsor of the rich-media content and with one another. FIG. 14D illustrates some further features permitting game playing, chat, review, critique and contribution by various users. FIG. 14E illustrates how the integration of branded player contents for shopping. FIG. 14F illustrates various channels that can be created, viewed and interacted with in accordance with the invention. FIG. 14G illustrates further channels and suggests branding within a branded player as well as contribution and interaction by users with a vendor, a sponsor and/or other consumers. FIGS. 14H-J illustrate a sports-oriented, branded channel that provides golf tips, interactive games, user contributions, and a product catalogue for shopping. FIG. 14K illustrates a stats-(statistics)-oriented statistical analysis and summary of a Chris Brown SplashCast® Channel, detailing such things as total application views, total show views, overall ratings, unique views, history and geography.

FIG. 15 illustrates another embodiment of the invention featuring a rich-media content management system (CMS) and demographically-targeted branded/sponsored consumer interaction at syndicated user nodes.

### DETAILED DESCRIPTION OF THE PREFERRED EMBODIMENTS

A rich-media content production and syndicated distribution system includes a rich-media content production mechanism including one or more studio production tools for producing content including at least one of dynamic or static images, dynamic video or audio, text, HTML, mixed media presentation, Microsoft PowerPoint slides, Adobe PDF pages, etc., wherein the produced content resides on one or more proprietary servers remote from a user of the production studio, and a syndicated rich-media content distribution mechanism including one or more distribution tools for publishing such content to consumers, wherein the content production and content distribution mechanisms collectively enable two-way, end-to-end, produce-and-distribute capability.

An Internet-based rich-media content production system includes a rich-media content production mechanism including one or more studio production tools for producing content including at least one of dynamic or static images, dynamic video or audio, text, HTML, mixed media presentation, Microsoft PowerPoint slides, Adobe PDF pages, etc., wherein the produced rich-media content resides on one or more proprietary servers remote from a user of the production studio, and a rich-media content feed mechanism operatively coupled with the content production mechanism, the content feed mechanism enabling the delivery of the produced rich-media content into syndicated publication.

A syndicated rich-media content production and distribution method includes providing a producer's web-based studio mechanism for producing a channel containing one or more feeds or shows, each feed or show containing an item, the item containing a scene, the scene containing a rich-media asset; providing a publisher's web-based rich-media player for publishing a channel including the one or more feeds or shows within an Internet webpage; and providing for a web-based collaboration between a producer and a publisher by which the producer is induced to produce one or more feeds or shows targeted for the provisioned publisher's player or by which the publisher is induced to publish a provisioned producer's feed or show not so targeted.

In accordance with one embodiment of the invention, the channel is source (e.g. producer) and destination (e.g. publisher or viewer) agnostic, such that any one or more feeds or shows can be published and viewed on any one or more webpage-embedded media players. In accordance with one embodiment of the invention, the channel also is dynamic, since the feeds or shows viewable thereon are dynamically changeable by the producer of the feeds, shows and channel. Finally, in accordance with one embodiment of the invention, a publisher's webpage featuring a feed or show or channel automatically is updated by the producer if the producer decides to change his or her channel content.

A website-embeddable rich-media content player apparatus is described. Finally, a brand-oriented rich-media content player is described that enables sponsored advertising in a blurred mix with rich-media content for interactive viewing and comment by demographically-targeted users.

### SUMMARY

SPLASHCAST® are trademarks owned by SplashCast Corp. World-wide rights are reserved.

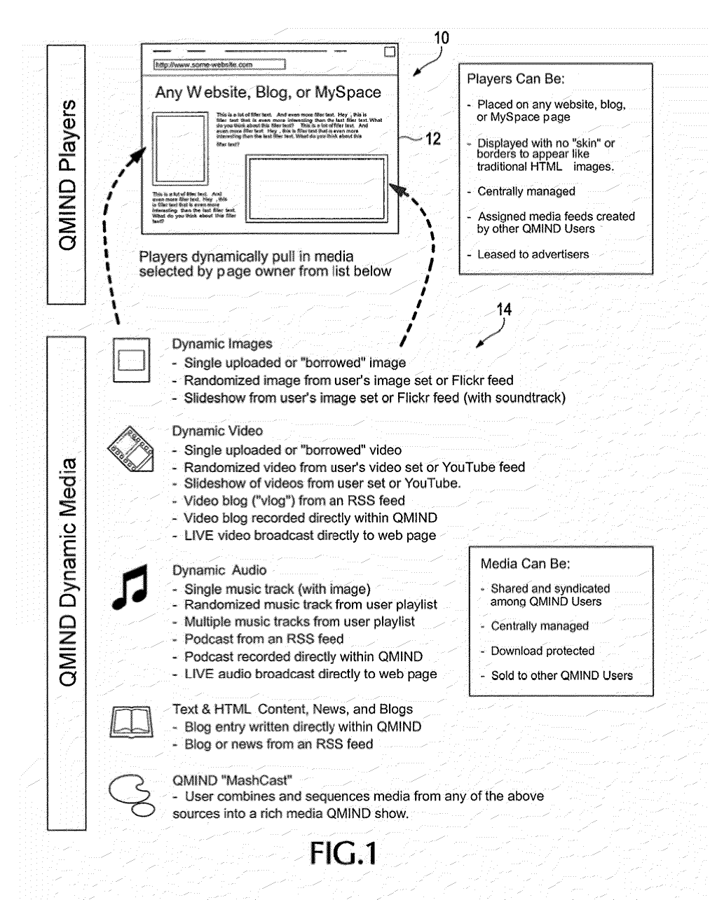

The SPLASHCAST® media model is illustrated in FIG. 1.

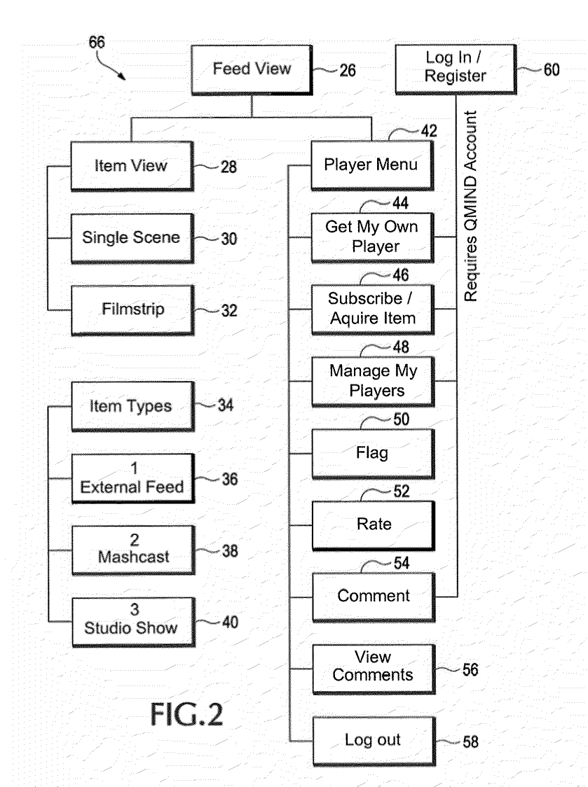

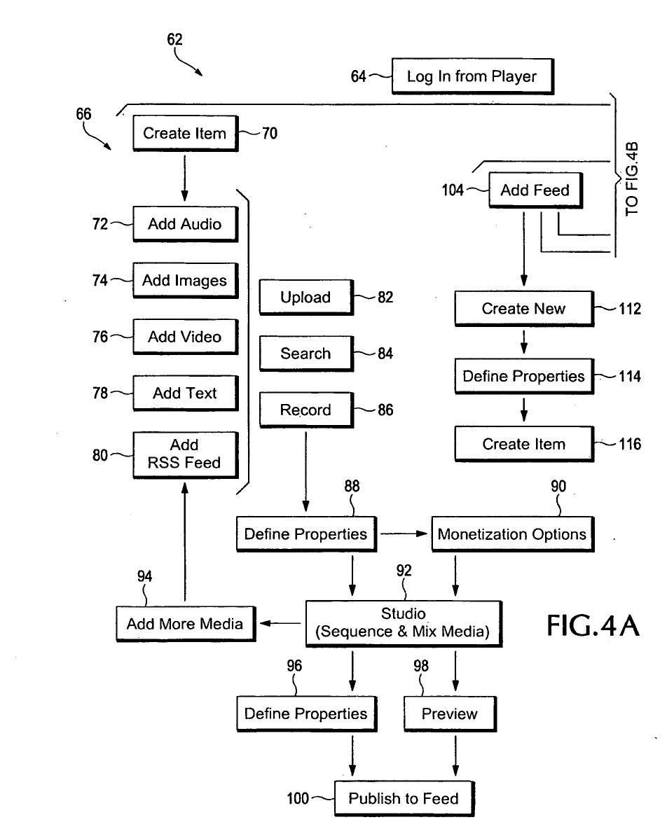

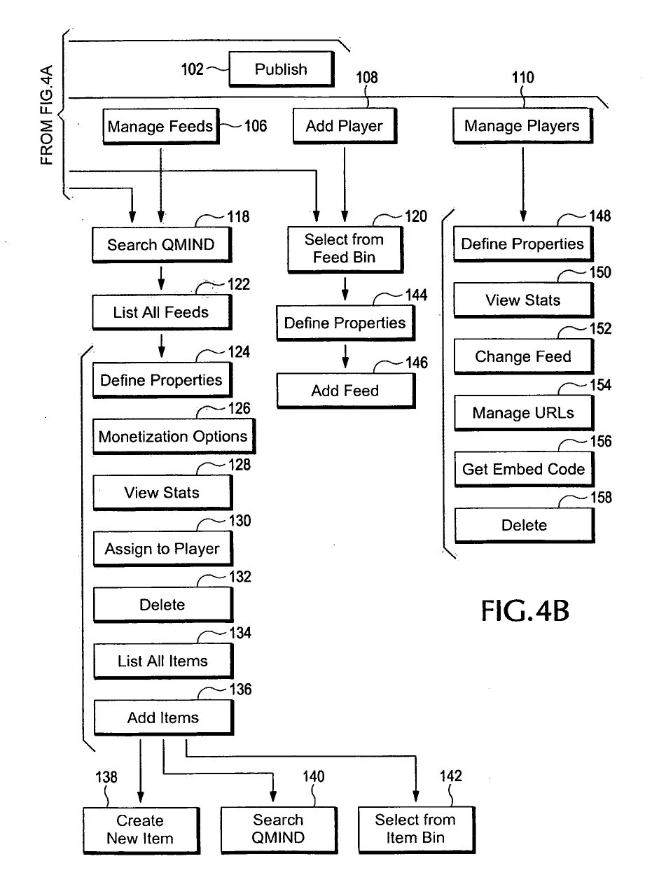

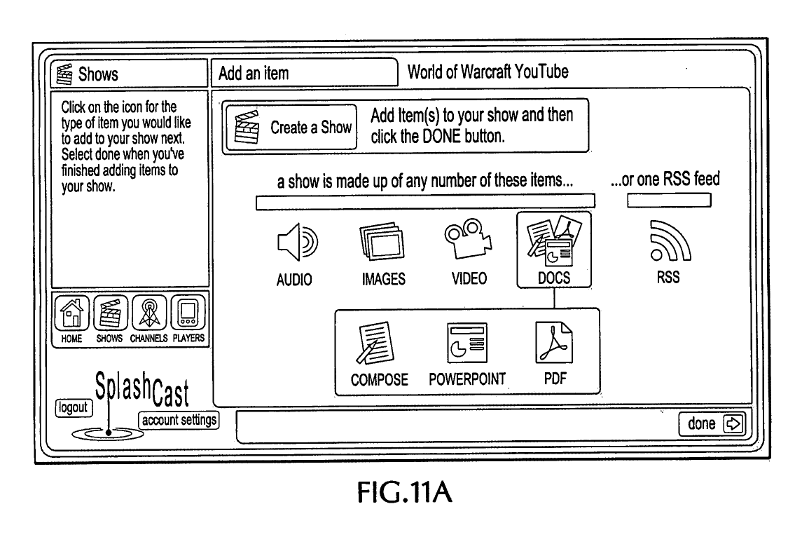

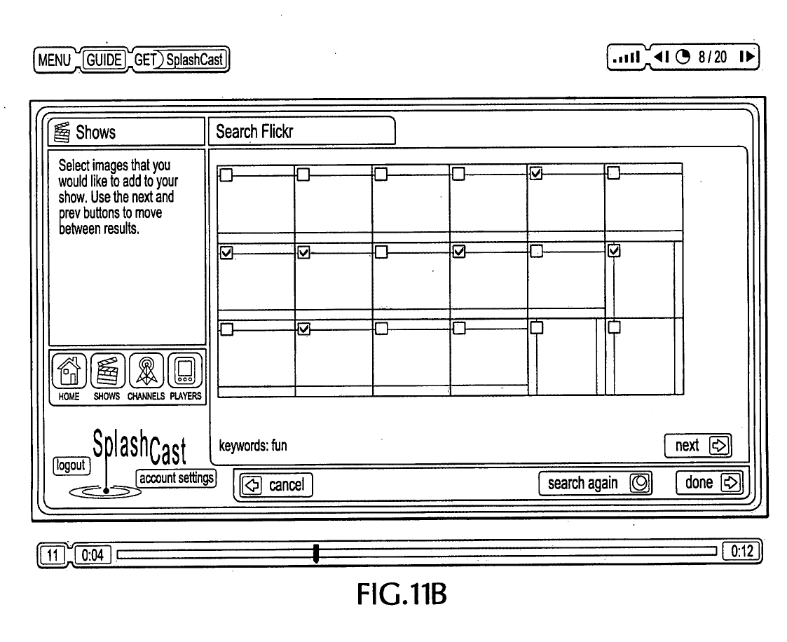

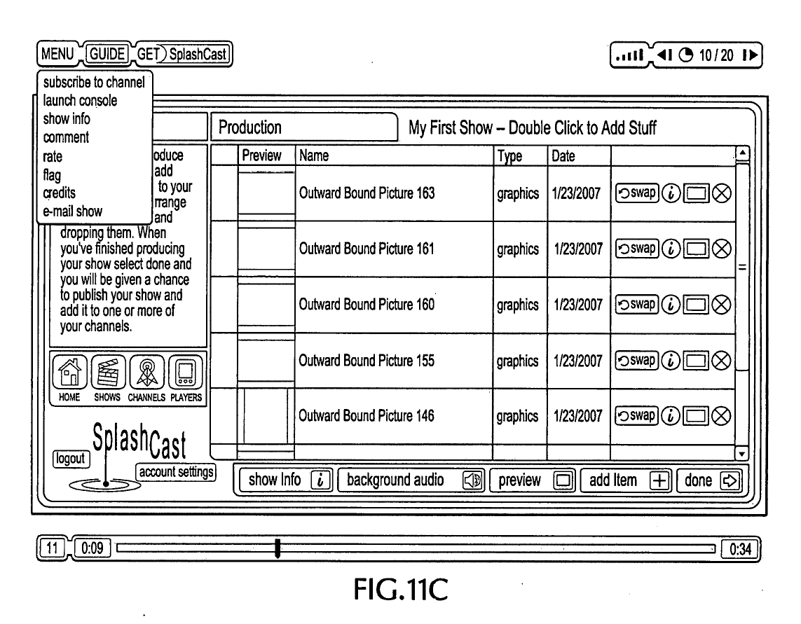

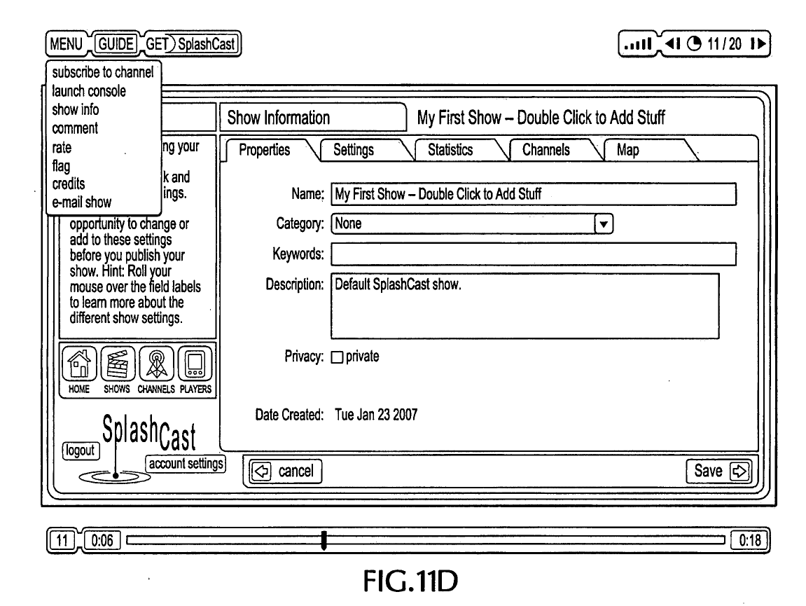

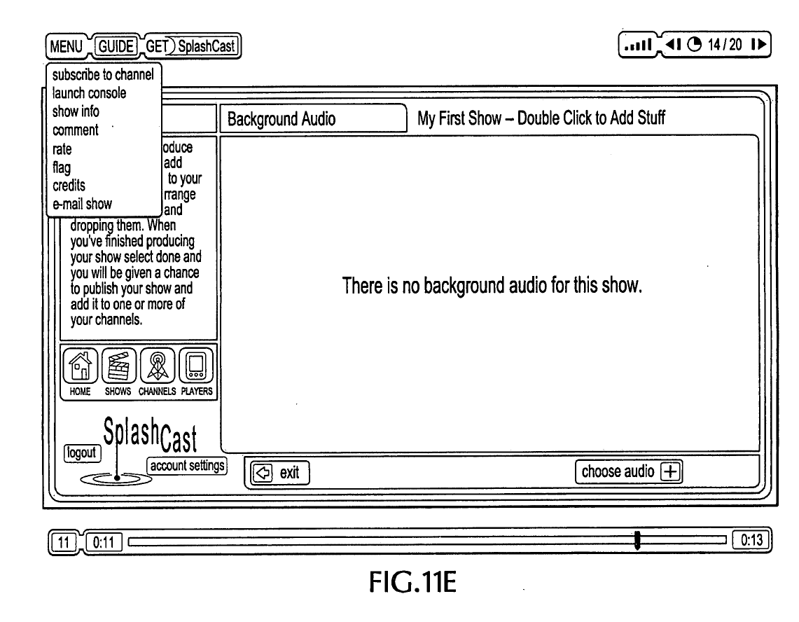

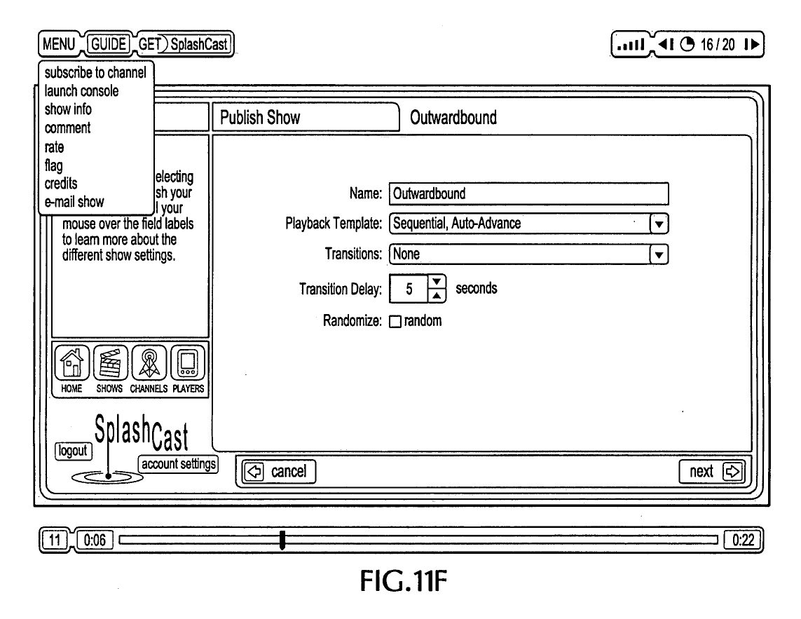

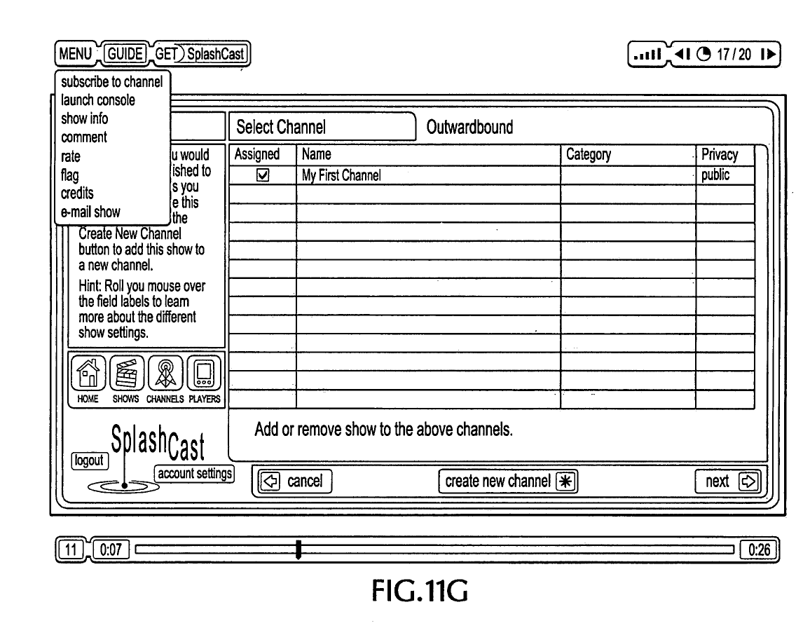

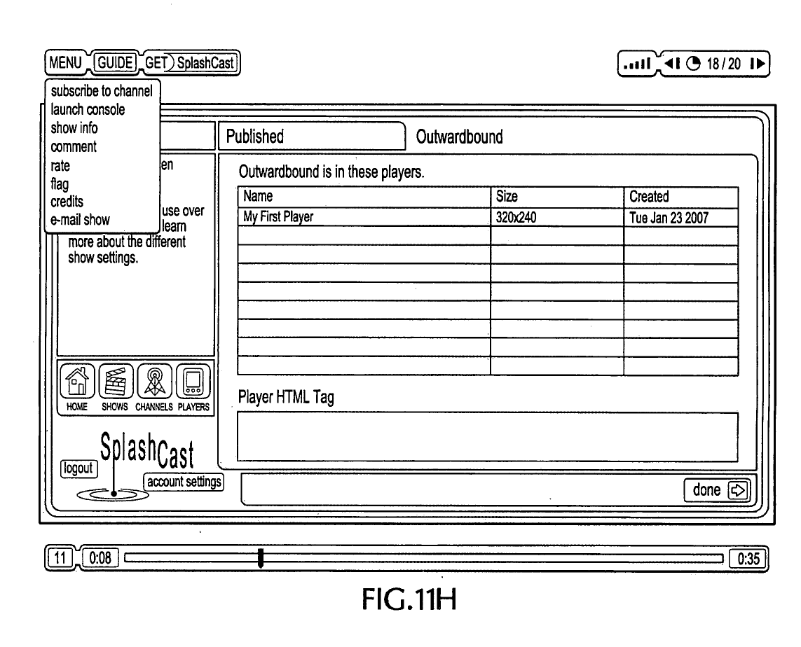

Novel SPLASHCAST® media ‘players’ (hereinafter Players) such as Player 10 are defined by a website owner to provide a multimedia offering that can be embedded in a window or region 12 of a website for viewing and interaction by and with a viewer. The webpage typically resides on a third-party (3P) server (not shown). One or more Players 10 can be placed on any website, blog, or MySpace page. They can be displayed with no ‘skin’ (conventional player control borders that typically include pushbuttons and slide buttons, as well as prominent branding) so that instead they appear like traditional HTML images, as illustrated. (Skinless Player 10 illustrated in FIG. 1 is truly invisible in FIG. 1, but will be understood to include the visible contents within window or region 12 as well as the Player functionality described below by reference to FIGS. 2 and 4. FIGS. 11A-11H described below illustrates such an embedded Player 10 and its functionality including visible (e.g. opaque or translucent) pushbuttons, pop-up menus, and other controls.) Their controls, described below by reference to the SPLASHCAST® Player Functional Diagram of FIG. 2, will be understood to become visible when the Player is “moused over.” They optionally can have a subtle watermark-styled logo or “bug” (not shown i) in window or region 12 to cue the viewer to the fact that the window-represents a dynamic media feed.

Skinless or unbranded Players like invented Player 10 heretofore are unheard of, but make sense in the context of the invention. This is because the owner of the website wants the media to “display” on his or her site but is uninterested in dedicating space for viewing controls, menus, and 3P branding.

One or more Players 10 can be centrally managed, as on one or more SPLASHCAST® servers. They can be assigned media feeds that are created by other SPLASHCAST® users. The players' contents can reside either on one or more SPLASHCAST® servers or on one or more 3P servers. If they reside on 3P servers, then pointers thereto reside on a SPLASHCAST® server for access to the 3P server-resident contents when the players are viewed or interacted with.

The media player dynamically pulls in media 14 selected by the webpage owner (“producer”) from any of the listed sources in the SPLASHCAST® Dynamic Media list, as illustrated in FIG. 1. Media 14 can be shared and syndicated among SPLASHCAST® users. They can be centrally managed, as on one or more SPLASHCAST® servers referred to herein as “proprietary” servers. They can be download-protected to preserve their integrity and distribution. They can be sold to other SPLASHCAST® users. Central management of Media 14 on one or more proprietary servers ensures against down-load and provides needed control and regulation of Player 10 contents.

Thus, the invention features a dynamic media distribution structure in which producers and publishers are in a two-way, end-to-end, create-and-distribute relationship. So how can novel Player 10 forming a part of the invention become rapidly adopted for multimedia? By embedding it subtly ‘behind’ each and every dynamic media window or region 12 and by inviting any viewer first to subscribe to his or her very own Dynamic Media Player 10. For free.

This is illustrated in the SPLASHCAST® Player Functional Diagram of FIG. 2. A Feed View block 26 represents that the viewer's cursor is ‘over’ dynamic media window or region 12 (this mouse position or cursor condition is referred to herein as “mouse-over”). Those of skill in the art will appreciate that, as used herein, mouse-over refers to any user-indicated cursor position relative to a display, whether indicated (“pointed at”) with a mouse or other pointing device such as a touch-sensitive screen, cursor control keypad or roller, voice command, etc., all of which mouse alternatives are contemplated for use in conjunction with the present invention and thus are within the spirit and scope thereof. Three options are provided:

1) a Single Asset Item View menu 28, e.g. of an Image (e.g. a JPG file), a Video (e.g. a FLV file), an Audio (MP3) file, a Multimedia (e.g. an SWF file) or an HTML or equivalent file. Those of skill in the art will appreciate that a Single Asset Item can take the form of a Single Scene 30 or a Filmstrip 32. Those of skill also will appreciate that a Single Scene can be a single photograph, for example, whereas a Filmstrip can be an ordered or randomized temporal (sequential) display of plural photographs, for example.

2) a SPLASHCAST® Show Item Types menu 34, e.g. of item types including 1) an External Feed 36, 2) a Mashcast 38 and/or 3) a Studio Show 40, any of which can take the form of multiple scenes in the form of a Slideshow (sequential use of the same space) or an Album (concurrent use of a shared space).

3) a Player Menu 42 including, e.g. Get My Own Player (Subscribe) 44, Subscribe/Acquire Item 46, Manage My Players 48, Flag 50, Rate 52, Comment 54, View Comments 56 and Log out 58.

Those of skill in the art will appreciate that more or fewer or different functions can be provided within the spirit and scope of the invention.

Some of the Player Menu 42 functional blocks can alternatively or additionally be accessed via a Log In/Register SPLASHCAST® website 60 by those who already know about the multimedia revolution stirred by the invention. These visitors can Get My Own Player (subscribe) 44, Subscribe/Acquire Item 46, Manage My Players 48 and/or Comment 54, as will be understood.

Flag 50 is used by the viewer of a player and by the SPLASHCAST® server to flag Digital Millenium Copyright Act (DMCA)-defined objectionable or infringing material, enabling SPLASHCAST® to take any required steps to delete the same from its servers. Rate 52 is used by viewers to rate a given Show or Feed 18, e.g. using a star system (as from one to five), and a cumulative rating can be viewed by others. Comment simply allows viewers to comment on what they think of a Show or Channel. Alternative rating and/or comment means or methods are contemplated as being within the spirit and scope of the invention.

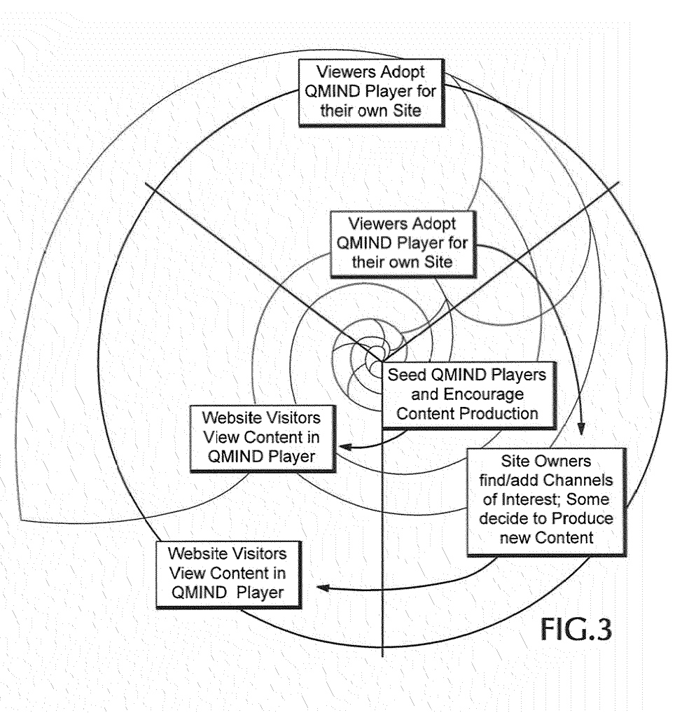

The rest of the functional blocks in FIG. 3 are self-explanatory, but it is emphasized that the prominence and order of the Get My Own Player block 44 encourages quick adoption and market penetration, making it very easy for SPLASHCAST® to get new producers and publishers of multimedia content. Yet, despite the prominent availability of the Player 10 subscription option, the menu and controls are subtly hidden in skinless form ‘behind’ the dynamic media window itself and pop up only when moused over.

Those of skill in the art will appreciate that the invented SPLASHCAST® Player 10, when it becomes visible during mouse-over, can function like any other, e.g. it can have conventional click-on player controls such as start, stop, pause, fast-forward, rewind, etc. and it can, within the spirit and scope of the invention, have different or additional player controls and can look and feel differently from conventional players. FIGS. 11A-11H described below illustrate one contemplated embodiment of Player 10 in accordance with the invention.

In brief summary, the invented system architecture is configured such that the content resides either on SPLASHCAST® servers accessible over the web or on 3P servers also accessible over the web via pointers residing in the SPLASHCAST® servers. Because the content is web-based and because content for which SPLASHCAST® is responsible resides in SPLASHCAST® servers, its integrity is unsurpassed. In other words, the content within Players 10 is current, is never downloaded and thus un-copy-able, virtually un-corruptible, and yet ubiquitously available to subscribers and other users. This centrally cast and content repository role of the proprietary SPLASHCAST® servers, coupled with limited access to the invented system software invoked online and executing only at the proprietary SPLASHCAST® servers creates end-to-end value for users while reducing risk. Thus, no actual SPLASHCAST® code resides on any user's computer, instead only an HTML tag is pasted into the user's webpage on the user's server, giving the user access to all of the unique features of the invented system.

FIG. 3 illustrates the viral adoption model in accordance with one embodiment of the invention. Adoption of the SPLASHCAST® system is referred to herein as viral because it typically grows exponentially rather than linearly. Thus, the outward spiral represented in background by a conch-like shell will be understood to go through timed phases. First, a critical number of production customers in the market are Seeded by providing them with a critical mass of SPLASHCAST® Players 10 along with strong encouragement to adopt and produce content for their own website. Second, Website Visitors view the produced content in the SPLASHCAST® Player 10. Third, Viewers Adopt the SPLASHCAST® Channel or Feed for their own website. Fourth, website Owners subscribe to Channels of interest and place (or re-publish) the subscribed Channel. Some website Owners decide to create new Channels and to produce and place (publish) new Channel content themselves using the simple and intuitive SPLASHCAST® studio production tool suite. Fifth, other Website Visitors View Content in the SPLASHCAST® Player 10. Sixth, other Viewers Adopt the SPLASHCAST® Channel for their own website by subscribing thereto. And so on and so on, with exponential growth in adoption by the marketplace.

FIG. 4 illustrates in block diagram form the behavior of the SPLASHCAST® Manager software mechanism 62 that forms a part of the invented system architecture. A user logs in at 64 from a Player 10 moused-over window or region 12 and chooses any one or more of the many functions provided by the SPLASHCAST® Console 66.

SPLASHCAST® Console 66 provides an elegant suite of soft tools in a studio environment that a producer visits online to Create an Item at block 70. For example, the producer can Add Audio at block 72, Add Images at block 74, Add Video at block 76, Add Text at block 78 and/or Add RSS Feed at block 80. (RSS, or Really Simple Syndication, is a published standard for XML-based content organizers and sharers.) Such varied multimedia content can be added by Uploading at block 82, by Searching at block 84 and/or by Recording content at block 86. The producer then Defines the Properties at block 88 of the one or more added contents optionally including the monetization options for each at block 90. In the Studio block 92, the producer Sequences & Mixes Media to produce a desired multimedia content offering that may include one or more of the Audio, Images, Video, and Text or a single RSS Feed optionally added at blocks 72, 74, 76, 78 and 80, respectively. The add process can be repeated by the producer to Add More Media at block 94.

When the producer is satisfied with the multimedia content, he or she Defines its Properties at block 96 so that it can be meta-tagged and later searched and, optionally, he or she Previews it at block 98 to ensure that it is ready to publish. The above steps can be repeated until the producer is satisfied that the multimedia content is ready to publish. When ready, the Created Show containing one or more Items or a single RSS Feed is Published to the Feed at block 100. SPLASHCAST® Console 66 also provides an elegant suite of soft tools that a publisher visits online to Publish a Feed at block 102. These tools include Add Feed at block 104, Manage Feeds at block 106, Add Player at block 108, and Manage Players at block 110.

Add Feed 104 permits a publisher to Create (a) New (Feed) at block 112, to Define the New Feed's Properties at block 114, and to Create an Item at block 116 that is to be part of the New Feed 18 (refer briefly back to FIG. 2). (Those of skill in the art will appreciate that the Create an Item reference designators 70 and 116 refer to the same functional block). Add Feed 104 alternatively permits a publisher to Search SPLASHCAST® at block 118 for an existing feed or to Select a Feed from the Feed Bin or repository at block 120.

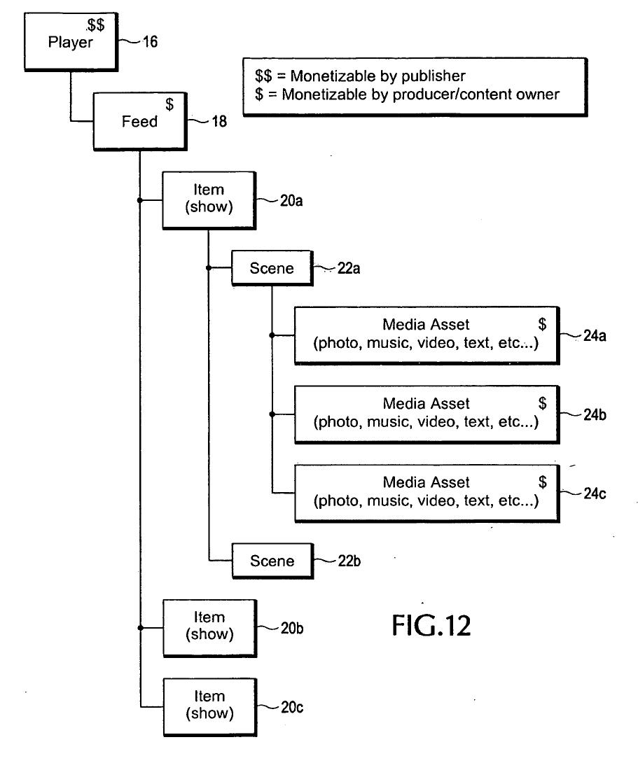

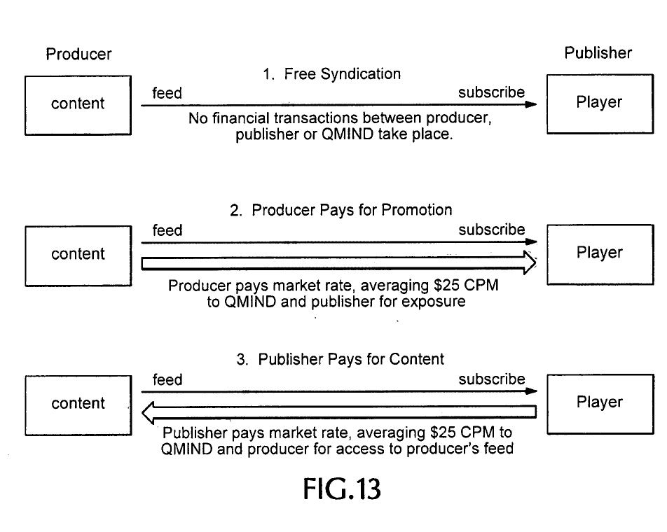

Manage Feeds block 106 permits a publisher to List All Feeds at block 122, Define Properties at block 124, choose Monetization Options at block 126 (as will be described further below by reference to FIGS. 12 and 13), View Stats (e.g. “hits” or number of views) at block 128, Assign a Feed to a Player at block 130, Delete a Feed at block 132, List All Items in a Feed at block 134, and Add Items to a Feed at block 136. Add Items can include Create New Item at block 138, Search SPLASHCAST® at block 140, and Select Item from Item Bin or repository at block 142.

Add Player block 108 permits a publisher to Define Player Properties at block 144 and to Add a Feed to a Player at block 146.

Finally, Manage Players block 110 permits a publisher to Define Player Properties at block 148, View Player Stats at block 150, Change Player Feed at block 152, Manage Player URLs at block 154, Get Embed Code for a given Player at block 156, and Delete a Player at block 158. Such Manage Players block 110, within the scope and spirit of the invention, may have more, fewer or different attributes.

From the above description and illustrations herein, it will be appreciated that SPLASHCAST® empowers non-technical individuals to personalize and publish all kinds of rich media dynamically to any website. SPLASHCAST® enables website owners to sell or lease media real estate on their sites while also giving content owners a secure, online distribution channel.

SPLASHCAST® technology makes it easy for individuals to find and create rich media on the web and then to syndicate it as an RSS feed, enabling others to easily add the content to their website or social networking page. Individuals now have a new outlet for creative self-expression, virtually without bounds in terms of the mixed media content they can create with SPLASHCAST®.

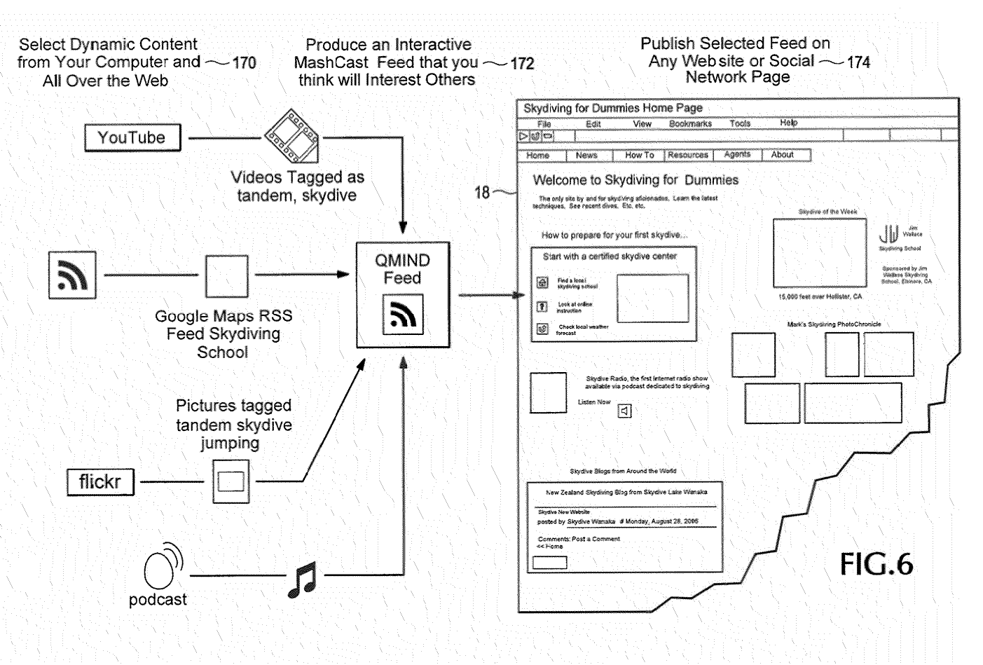

FIG. 6 illustrates the versatility of the invented system, wherein Interactive Mixed-Media so-called “MashCast” content 160 is augmented by Dynamic Video or Vlogs 162; Dynamic Images or Slideshows 164; Text Content, News, or Blogs 166; and Dynamic Audio, Music, or Podcasts 168 in relation to Skydiving for Dummies to create a Feed 18 suitable for publishing on a website having a window or region inhabited by a Player (e.g. Dynamic Media Player 10 embedded within window or region 12 as illustrated, but with different content, in FIG. 1).

With SPLASHCAST®, now, non-technical individuals can:

Create, publish, & syndicate a mixed media MashCast production;

Produce high-quality music videos;

Develop instructive tutorials and do-it-yourself content;

Simplify podcasting and video blogging with “one-stop” production and publishing;

Broadcast friends' content feeds on MySpace and other social network pages; and

Much, much more . . . .

The SPLASHCAST® skinless web-based media Player 10 gives the site owner total control of how media appears on their webpage, while giving the owner of the content feed 18 complete control over what content is served up. Using SPLASHCAST®, anyone can easily add dynamic, centrally-managed rich media to their webpage; no mess, no fuss.

With twelve million blogs and counting, millions of photographs on Flickr, hundreds of thousands of videos on YouTube, and growing availability of non-restricted sound tracks, average people have access to massive amounts of media content—user created as well as professional—to make their websites and social network pages more expressive, interesting, informative, educational, or just fun.

But it is not easy for average people to personalize media aggregated from various sources, nor is it easy to publish the content directly to their website. It is even more difficult then to syndicate the content so that others with similar interests can incorporate it into their websites or social network pages. This is what SPLASHCAST® enables anyone to accomplish.

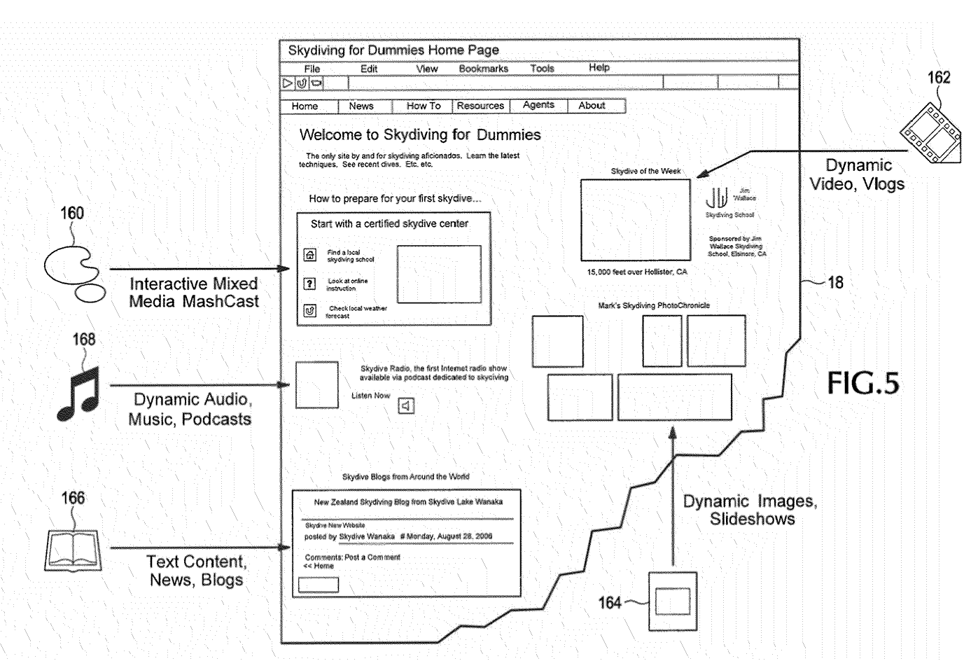

FIG. 6 illustrates how straightforwardly a Feed or Channel 18, e.g. the Skydiving for Dummies Feed featured in FIG. 5, can be created, in accordance with the invention. The user:

a) At 170 selects dynamic content from his or her computer and elsewhere, e.g. he or she downloads dynamic content from the Internet. Such content can include videos tagged as tandem/skydive, Google maps and RSS feeds about a skydiving school, pictures tagged as tandem/skydive jumping related, and music or other audio track;
b) At 172 combines all such selected dynamic contents to produce an interactive MashCast that the user thinks is of interest to others; and
c) At 174 publishes The MashCast Feed on any one or more websites or social network pages.

By empowering mere mortals to find, personalize, and syndicate media into dynamic feeds, SPLASHCAST® is pursuing a bold, new model for content distribution on the web. Rather than forcing people to frequent destination sites for community, information, and media content, such can now be found on any web page and personalized by the web page owner. So one might see that cool video of twenty Elvises skydiving (recently posted on YouTube) appear on Mike's MySpace page, but now it is choreographed to “Heartbreak Hotel.” And on Kim's Skydiving for Dummies website, Kim's audio commentary explains how “one Elvis landed hard and broke his pelvis”. Meanwhile, the owner of the original video will be able to track how far and wide the video has been remixed and syndicated. As such, SPLASHCAST® allows content owners the same kind of bragging rights for the popularity of their rich media that one sees today with popular blogs.

The evolution of the Web 2.0 phenomenon has had a significant impact on how people are using the Internet to communicate and express themselves. It has resulted in an explosion in the number of websites on the Internet. Young people are embracing social networks and everyone is uploading massive amounts of personal content of all kinds onto the Internet with the intent of sharing it with others. In this area, people use blogs as a platform or podium to express their thoughts, ideas, and opinions. They also use image sharing sites such as Yahoo's Flickr to share their photographs. A very recent and rapidly growing example of this kind of self-expression and sharing is exemplified by video sharing sites such as YouTube, which amazingly gets 100 million video views each day.

This migration to Web 2.0 has exponentially expanded the number of websites and the sources of content. In 1996 and the Web 1.0 world, there were forty-five million global users of some 250,000 websites and by far the highest percentage of content was published rather than user-generated (according to Dion Hinchcliffe's Web 2.0 Blog). A decade later, in 2006 and in the Web 2.0 world, one billion global users now substantially equally read and write on some eighty million websites.

In the context of blogs, podcasts, and news feeds, there has emerged a technical standard for syndication and distribution of content, that being industry-standard RSS (Really Simple Syndication). While it is not easy today for the non-technical populace to create or subscribe to RSS feeds, it has become a common mechanism for websites to subscribe to published content and for more sophisticated bloggers to make their content available via other websites.

The convergence that is occurring between these key Web 2.0 trends, social network sites for collaboration and rich media sites and blogs for sharing content, combined with the technical “plumbing” offered by RSS, has created the opportunity for SPLASHCAST® to find novel ways to distribute user-generated content.

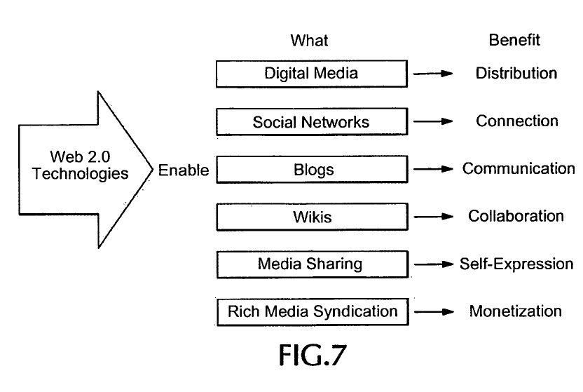

FIG. 7 illustrates how social networking and user-created media open wide the door for rich media syndication in accordance with the present invention by which a need for rich media syndication and monetization can be fulfilled. FIG. 7 shows that Web 2.0 Technologies enable digital media to benefit distribution, enable social networks to benefit connection, enable blogs to benefit communication, enable wikis to benefit collaboration, enable media sharing to benefit self-expression, and, in accordance with the present invention, finally now enable rich-media syndication.

SPLASHCAST's SPLASHCAST® offering is designed around the concept of extreme simplicity of learning and use so that mere mortals can create cool, dynamic content, place it on their web pages, make it available for others to publish, and track how far it has spread on the Internet. This tracking feature, as well as a novel mapping feature, of the present invention will be further described below by reference to FIG. 11D.

The core of SPLASHCAST® technology is in its ability to separate the display of content from the control of content, e.g. to separate the Player 10 from the Console 66. Rather than using a static cut-and-paste or pointer approach, SPLASHCAST® models its approach on that used for production of television, where one entity produces and controls the content in the show, syndicates it as a feed and makes it available over the network, and another entity displays the content by accessing and publishing the feed.

SPLASHCAST® enables individuals to be producers to create a feed with professional-looking rich media content of their own or from anywhere on the Internet. With the explosion of user-generated content, a whole, new world of rich media is created. SPLASHCAST® also makes it easy for anyone with a website, whether a personal site, a MySpace or Facebook page, a site for a community of interest, or a business site, to be a publisher and to incorporate such a Feed into the website to enhance its value and interest.

Central to the product offering is the SPLASHCAST® Player. The SPLASHCAST® Player is a FLASH-based web application. SPLASHCAST® allows the owner of any web or social network page to “drop in” the Player and select a content feed for display. Unlike typical media players today that most are familiar with, the SPLASHCAST® Player is 100% Internet-based, is simple for anyone to add to a webpage, and is simple for anyone to select his or her desired content from anywhere to display. This ease of use will be illustrated by reference below to FIGS. 11A-11H.

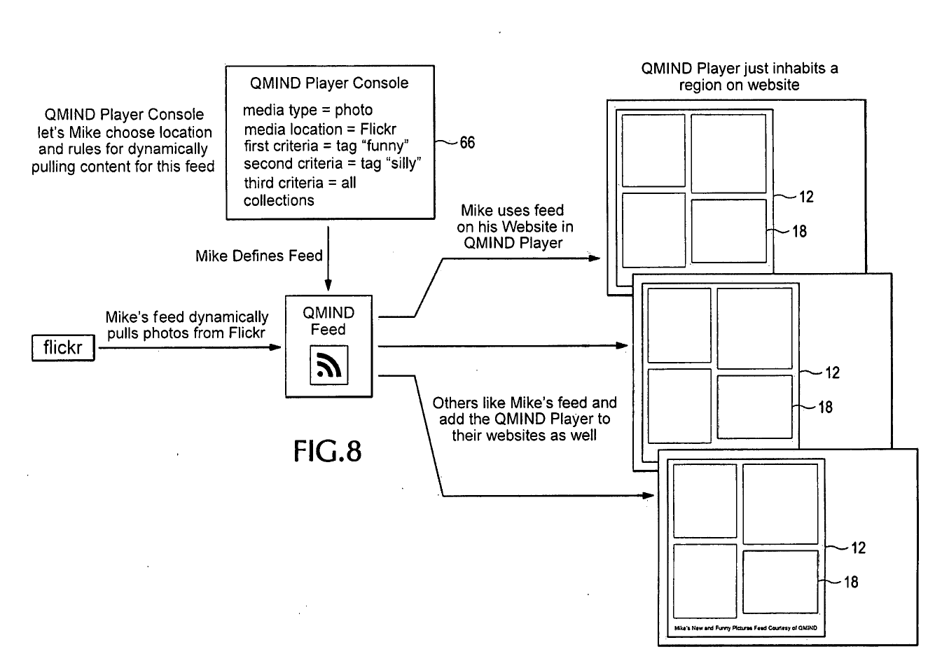

FIG. 8 illustrates the display of dynamic, centrally-managed rich media content using the invented SPLASHCAST® Player 10 described herein. A SPLASHCAST® Player Console 66 (refer briefly to FIG. 4) permits a user (e.g. one named Mike) to choose location and rules for dynamically pulling content for the illustrated Feed 18 about funny or silly photos. The user has chosen media type=photo, media location=Flickr, first criteria=tag “funny”, second criteria=tag “silly”, and third criteria=all collections to define his feed. The user's feed dynamically pulls photos matching the defined criteria from Flickr. The user employs the defined SPLASHCAST® Feed or Channel 18 on his or her website in the SPLASHCAST® Player 10. Others see the user's Feed and add the SPLASHCAST® Channel featuring the Player to their websites as well. Those of skill will appreciate that the SPLASHCAST® Player 10 thus effectively inhabits a window or region 12 on a website, as illustrated in FIG. 8.

Key to the design of the SPLASHCAST® Player 10 is that it is simple, unobtrusive, and easy to embed into any website. The SPLASHCAST® Player 10 will not have any “chrome”, so to speak; it will be “skinless.” This is a radical idea in the world of media players, but makes total sense from the perspective of the owner of the website. They want the media to “display” on their site but are uninterested in dedicating space for viewing controls, menus, and company branding. The SPLASHCAST® Player 10 will simply display media in a window whenever possible.

Media-specific controls become visible and active on mouse-over, as appropriate, and also use a subtle watermark-style visual interface. The controls allow the visitor to control playback of the media as appropriate, and also provide a means to learn more about the Feed 18, and how to use the SPLASHCAST® Player 10 with this or another Feed 18 on one's own website. It is this last aspect, where viewers of a Feed 18 see how easy it is for them to add rich media content to their own website or social network page, wherein the power of viral growth comes into play. When one visits a website and sees a Player one is just a click away from a quick decision to get a Player.

While initially users may add SPLASHCAST® Players 10 to their webpage because they would like to show a cool Feed 18, they quickly will realize that it would be fin and easy to create their own custom Feed 18. Thus, content for the SPLASHCAST® Player 10 can be “programmed” using the SPLASHCAST® Console 66. The SPLASHCAST® Player Console 66 is the simplest way for individuals to produce content for the SPLASHCAST® Player 10. It is an Internet-based application that makes it easy for a non-technical user to add specific dynamic content Feeds 18, effectively creating a filter for content, to display and interact with in the Player 10.

With the SPLASHCAST® Player Console 66 being accessible directly from any place on the Internet, a user can simply create a custom feed from a media-sharing site such as Flickr or YouTube using a pre-defined set of available criteria (based for example on posting date, metadata tags, collection or set, etc.). So, for example, a SPLASHCAST® Feed 18 might specify the “latest 10 videos posted to YouTube, with ratings>4 stars, with over 1,000 views, who's tags include “funny” or “comedy” or “silly”.”

SPLASHCAST® Console 66 allows non-technical users to create more sophisticated rich media and interactive content feeds. SPLASHCAST® Console 66 is also an Internet-based application, but it allows the user much greater flexibility in specifying, aggregating, displaying, and interacting with rich-media content. For instance, it helps in defining timing and effects for transitions, panning/zooming on images, and setting up interactive menus that can drive the display of text, images, video, and the play of sounds and music.

SPLASHCAST® enables mere mortals to easily access and produce all kinds of rich-media content for themselves and others to simply drop into their websites. Today it is common for someone to add a song or a video or pictures to their websites. However, only commercial sites like CNN.com, SI.com, and the like have the technical wherewithal to provide dynamic, up-to-date content available from their syndicators for selection and viewing on their site by the public.

The present SPLASHCAST® invention changes all this.

SPLASHCAST® makes it easy for anyone to create or incorporate a video, image, audio, news or blog, or other RSS feed that is dynamic and will access content that the content producer specifies. Because public media sites like Flickr, YouTube, and others allow search and access of content based on tags and other filtering information, a SPLASHCAST® Feed can serve up photos, for example, that have just been added to Flickr that have the same tags that the user has specified when producing the Feed. And any others with websites can then add that Feed to their own webpages without any programming expertise. They can also easily record narration for each slide and add a soundtrack to the entire slideshow. This creates a very powerful and broad-reaching paradigm for addressing the huge volume of rich media being created and the increasingly segmented communities of interest that frequent various websites.

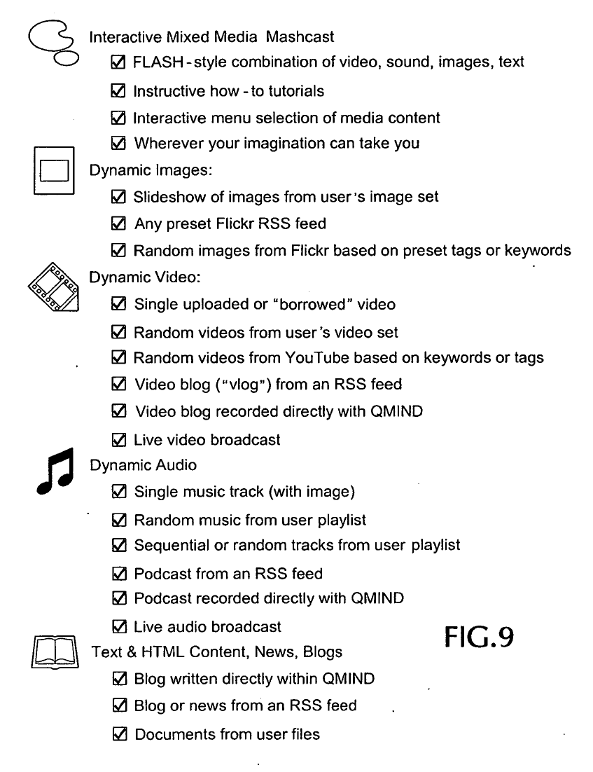

Self-explanatory FIG. 9 illustrates the breadth of the options provided by the invention for creation (production), syndication and publication. Those of skill in the art will appreciate that rich multimedia contents now virtually limitlessly are subject to production, publication, and consumption.

SPLASHCAST's SPLASHCAST® offering has the necessary ingredients for creating a viral adoption process and a corresponding exponential adoption curve. Rather than seeking to attract a user base to a destination site and compete with already established players in rich media and social networking, SPLASHCAST® will use the power of syndication to enable the mass of participants in this ecosystem to consume a broad array of user-generated and premium content of interest.

The SPLASHCAST® Player 10 is the key to the viral growth model, as mentioned above by reference to FIG. 3. Viewers of content at websites and social network pages with SPLASHCAST® Players 10 to display rich media content will see how easy it is to publish similar content on their own website or social network page. Just as people today add feeds for blogs to their sites on a massive scale, SPLASHCAST® will expand this paradigm and enable feeds for rich media to be added via the simplicity and power of the SPLASHCAST® Player 10.

When viewing rich-media content on a website that is in a SPLASHCAST® Player 10, viewers are subtly presented with the choice of adding the Player 10 and its related content to webpages of their own. Once added, the users can easily create their own personalized rich-media Feeds 18. They also can search for and choose from an array of content Feeds 18 that are available to play on their site. This will reinforce the cycle of creating new Feeds 18 and demonstrating the variety of content that is available to publish.

SPLASHCAST® will initially focus on driving adoption of the Player 10 by encouraging individuals to use it to see how easy it can be to publish interesting, dynamic, free content from various video and image sharing sites, blogs, podcasts, and other RSS feeds on any other their websites or social networking pages. Over time, some content publishers will see the opportunity to monetize their website popularity by allocating some of their Internet real estate for paid promotion of rich-media content. As adoption of the Player reaches significant levels, there will be a corresponding increase in value of this as a distribution mechanism to owners of premium content. This will drive distribution of such content for payment by website publishers. Such a mechanism represents a new opportunity for premium content owners to expand into new distribution channels. Additionally, SPLASHCAST® provides copyright owners the comfort of knowing exactly who is syndicating their content, what websites it appears on, how many times it has been accessed, and the security of knowing it can never be downloaded nor distributed outside the SPLASHCAST® network.

The competitive environment surrounding social networking and media content is very busy. SPLASHCAST's competitive product distinction is that it provides value end-to-end, from rich media production to publishing, and in being agnostic to source and destination.

SPLASHCAST® may be perceived as competing with rich-media production tools, user programmable “widgets”, and syndication services. While SPLASHCAST® will offer some functionality that overlaps with such offerings, it is the combination of capabilities for design, syndication, and publishing of rich-media content that distinguishes SPLASHCAST's invented SPLASHCAST® apparatus, system and method. To this end, the invented SPLASHCAST® apparatus, system and method differentiate themselves from tools such as OneTrueMedia, Jumpcut, and Grouper for producing rich-media content. These services are primarily focused on video (and image) aggregation and editing, rather than the production, syndication, and monetization of the full spectrum of dynamic rich media.

SPLASHCAST® will not focus on single-site or single-function applications, such as the plethora of “widgets” that have been developed for Google Desktop, blogs, and MySpace. While useful, these types of web-base applications lack the end-to-end value that will make SPLASHCAST® compelling to (individual) publishers of user-generated content. Examples of these potential “widget” competitors include Stickam and TheSpringBox.

SPLASHCAST® provides a simple yet comprehensive strategy to balance the rights/needs of the holders of copyrighted and valuable content with the dynamic sharing environment that has emerged for a lot of user-created content. The two elements of this strategy include, one, to treat media assets that are included into the SPLASHCAST® network for use, and, two, to address the creation of media Feeds and their fair use.

Relative to media assets, SPLASHCAST® distinguishes between existing assets that are already hosted on a sharing site that has already required the asset holder to assign a license type to the asset that dictates fair use. Some media sharing sites assign a default Creative Commons license type which can be altered by the asset owner. A SPLASHCAST® user will be required to acknowledge via a click agreement that they will abide by the license terms under which a particular asset is shared.

SPLASHCAST® users may also upload media assets of their own onto the SPLASHCAST® site for their own use and/or for use by others in creating SPLASHCAST® media Feeds. In this case, SPLASHCAST® will assign a default Creative Commons license to each asset based on whether the asset is specified by the owner as private (meaning view-only to most but editable by the creator), public (usable, e.g. editable, by others at will for creating derivative works or Feeds), or commercial (usable by others, including others' Feeds in derivative works, for free or in accordance with a fee schedule). In the case of private assets, SPLASHCAST® will assign an All Rights Reserved license. For both public and commercial assets, SPLASHCAST® will assign an Attribution license.

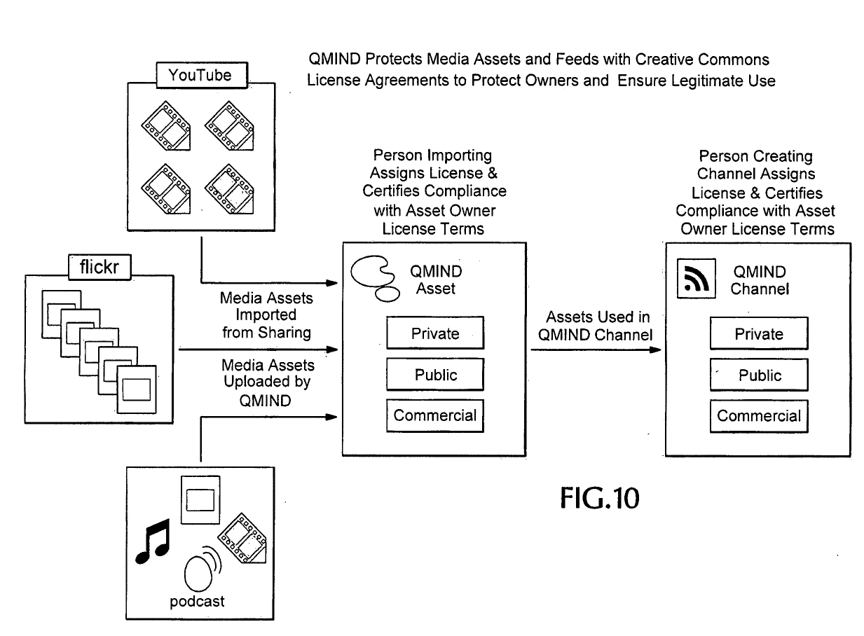

FIG. 10 schematically illustrates how the invented system protects media assets and Feeds to protect owners and to ensure legitimate use of copyrighted assets. With the above discussion, FIG. 10 is believed to be self-explanatory.

FIGS. 11A-11H illustrate some of the user interface features of the SPLASHCAST® Player 10 and production-and-syndicated-distribution methods in accordance with one embodiment of the invention. Those of skill in the art will appreciate that the user interface or so-called “look and feel” of the Player may be different, as is contemplated, yet within the spirit and scope of the invention. In FIG. 13A, Player 10 Console 67 can be seen in the form of a tutorial to permit one or more Items such as photos to be Added, as obtained from a Flickr™ database search.

It will be appreciated by those skilled in the art that FIG. 11A is ‘skinless’, representing the fact that the user's mouse or cursor control device is outside the Player Console's rectangular boundaries.

FIGS. 11B through 11H in contrast illustrate the Player Console with its Player “frame” including command/control buttons and indicators more like conventional players. Those of skill will appreciate that, in accordance with one embodiment of the invention, the Player's skin is persistent for a short time, e.g. a couple of seconds, after the mouse exits the field. Those of skill in the art also will appreciate that it is the optionally skinless Player that renders a Rich-Media Player to be embedded discreetly within a webpage, as described herein.

FIG. 11B illustrates thumbnails of selected (check-marked) and non-selected photos therefrom to be saved as added Items. FIG. 13C illustrates the selected photos arranged in a sequence that can be clicked, dragged and dropped to change the original sequence to a revised sequence. FIG. 11C also illustrates the drop-down menu including the subscribe to channel, launch console, show info, comment, rate, flag, credits and e-mail show options that generally are described above by reference to FIG. 2. FIG. 11D illustrates the show information window with the properties tab visible (behind which additional tabs provide for viewing of settings, statistics, channels, and maps). Those of skill will appreciate that keywords can be entered to assist in categorizing the show for later reference and/or use in topical searches by others. Those of skill also will appreciate that selecting the map tab opens a window that graphically identifies the geographies of persons who have viewed the show along with other viewer information. Fewer, different, or more tabs or features may be provided, within the spirit and scope of the invention.

FIG. 11E illustrates that there is presently no background audio for the show. Those of skill will appreciate that by clicking the choose audio button, the producer of the show very simply can choose an audio background (refer to FIG. 11A). Thus the producer of a show can choose any combination of one or more audio, photo, video or text Feeds, or a single RSS Feed, to create multimedia content in the form of a Show.

FIG. 11F illustrates how a show is published by choosing a name for the show (“Outwardbound”); a playback template, e.g. Sequential, Auto-Advance v. click to advance; a transition for fades as between photos; a transition delay; and a random (shuffle) or sequential play presentation. FIG. 11G illustrates how the Player permits the producer of a Show to select a channel that will feature the Outwardbound Show, e.g. the default channel named My First Channel, its category and an indicator whether it is public or private. Finally, FIG. 11H illustrates to which Players the Outwardbound Show, which for the moment is the only Show in My First Channel, is published. For the moment, the published-to Player name is the default My First Player, of size 320×240 pixels, and the creation date is Tue. Jan. 23, 2007. Those of skill in the art will appreciate that, in accordance with one embodiment of the invention, Players are scalable.

Those of skill in the art will appreciate that channels can be thematic or can have some other “logic” or organization to them. For example, they can represent a period of time or a season, a favorite activity such as skiing or snowboarding, a place such as the outdoors, road trips, and thus can categorize Shows within the Channel as related in any desirable way. Accordingly, the Channel organization described herein is merely illustrative of the invention and is in now way limiting.

Those of skill also will appreciate that the Player HTML Tag window when moused over with a cursor contains the HTML code that, when copied to another's browser, provides a link to My First Player, where the published OutwardBound Show featured on My First Channel can be viewed (but not downloaded) by anyone familiar with or new to SPLASHCAST®.

Because media assets in SPLASHCAST® cannot be downloaded by anyone (their consumption will be solely “on demand” for syndication or viewing, and not copy-able), SPLASHCAST® will be able to track asset usage and also to take an asset out of use (for example, if it is being used inappropriately or if the asset is considered not to meet the criteria required by SPLASHCAST® (pornographic material, for instance)).

For media Feeds, the invention uses a similar licensing model as for media assets. SPLASHCAST® Feeds can be private (again, meaning view-only but for the use/publishing by the creator), public (subscribable by others at will), or commercial (subscribable by others for free or in accordance with a fee schedule). Each of these classes of Feeds will be assigned the same Creative Commons license type as for similar assets. And creators of Feeds must further directly acknowledge via a click selection that their creation of the Feed meets with legitimate use criteria of any material that they may reuse, such as assets from Flickr™, YouTube™, and the like, and that the license for these assets in the Feed is based on that of the original copyright holder.

SPLASHCAST® implements a number of operational procedures to ensure compliance with the Digital Millennium Copyright Act (DMCA). (The DMCA regulates the production and dissemination of technology capable of circumventing copyright protection measures. It also heightens penalties for copyright infringement on the Internet. Finally, the DMCA provides statutory “safe harbors” that avoid its potentially harsh results.)

When notified by the copyright holder of a media asset hosted on the SPLASHCAST® asset site, or being published via a SPLASHCAST® channel on a website, that it either was not posted by an authorized party or that its use in a feed is not in compliance with its licensing terms, SPLASHCAST® will follow the processes defined by DMCA to remove the asset from its database or from the offending Feed, as requested. In order to comply with the Communications Decency Act, SPLASHCAST® will monitor assets that are posted for use and delete those that are considered offensive or indecent, or which they have been notified of by others as being such.

This DMCA compliance goal is facilitated in accordance with the invention by the use of the SPLASHCAST® Player's Flag functional block, as described above by reference to FIG. 2.

SPLASHCAST® will look to the adoption of the SPLASHCAST® Player as a means of publishing dynamic rich-media content on websites and social networking pages as the key initial indicator and measurement of success. The SPLASHCAST® viral growth model, as described earlier, is predicated on use of the Player on websites, resulting in exposure to a population of visitors to the website, resulting in adoption of the Player by said viewers, with the creation of new content feeds at all stages in this evolution.

But SPLASHCAST® does not stop there. SPLASHCAST® has also developed a new model for expanding the monetization of rich media on the web. First, media content owners can expand the distribution of their material to include websites and social network pages where there is a willingness to pay to publish premium content. Just as people are willing to pay separately today for ring-tones, website owners and those with social network pages will pay to incorporate their favorite music and TV episodes. Second, owners of popular websites can sell media real estate on their sites to content owners that are motivated to promote themselves and their work. Imagine all the garage bands that would be highly motivated and happy to pay popular music websites for the real estate to expose their music videos on these highly trafficked sites. Thus, over time, some content publishers will see the opportunity to monetize their website popularity by allocating some of their Internet real estate for paid promotion of rich-media content. As adoption of the Player reaches significant levels, there will be a corresponding increase in value of this as a distribution mechanism to owners of premium content. This will drive distribution of such content for payment by website publishers. Such a mechanism represents a new opportunity for premium content owners to expand into new distribution channels.

FIG. 12 illustrates a Content & Monetization Hierarchy or structure that optionally can be implemented in accordance with one embodiment of the invention. Those of skill in the art will appreciate that the illustrated structure is only one of many possible structures contemplated as being within the spirit and scope of the invention. Thus, FIG. 12 will be understood to be illustrative of one possible inventive aspect of the invention but not limiting in any way.

The “$$” in the upper right corner of Player block 16 represents money that can be earned by a Publisher of content. For example, a Publisher can lease or sell a Player 10 space (by use of what will be referred to herein as a “space-available mechanism”) within a website to a producer of high-value, premium content. The Producer is willing to pay for such Player 10 space because of the number of website visitors who will view or interact with the production. The “$$” in the upper right corner of singular Feed block 18 represents money that can be earned by a Producer or owner of content. (Those of skill will appreciate that, while only one Feed block 18 is shown per Player 10, more than one can be provided, within the spirit and scope of the invention.) For example, a Producer can sell a production to a website owner for use in a Player 10. The website owner is willing to pay for such a Feed 18 because the value of the website is enhanced by inclusion of the production. Feed 18 can include one or more Items 20a, 20b, and 20c, or so-called “shows”, each of which can include one or more Scenes 22a and 22b, each of which can include one or more Media Assets 24a, 24b, and 24c. The “$$” in the upper right corner of Media Assets blocks 24a, 24b, and 24c represent money that can be earned by an owner of a Media Asset such as a photo, music, video, text, or other media 14. Such Media Assets 24a, 24b, and 24c are purchasable for value by the producer of Feed 18 that features them.

Those of skill in the art will appreciate that one or more Players 10 themselves may acquire marketable value as an Item such as Item 20a. For example, one or more Players 10 in the form of one or more Items 20, in accordance with one monetization model according to the invention, can be leased to advertisers for a price such as $25/1000 views ($25 CPM). In other words, the hierarchy or structure contemplates that a Producer can become an owner of Item 20a, wherein the Item itself contains a multimedia content. Indeed, very involved customers of the invented Dynamic Media system may assume one or more roles concurrently or sequentially as the market and they themselves mature.

It is not a necessary part of the invented system architecture that every production or publication is a monetary event. For example, philanthropic or public service producers may not want money for their multimedia content contributions, they may instead simply want exposure or goodwill. Such exposure can be provided in such a transaction by a credits list appended to the end of a production, by a watermark or ‘bug’ logo or other discreet indicium overlaying the image, or by any other suitable means. Anonymity of contribution of course is also possible, with or without compensation to the contributor.

Those of skill in the art will appreciate that, in accordance with the embodiment of the invention illustrated in FIG. 12, there is only one Feed 18 per Player 10. This is a straightforward implementation and of course does not limit content in any way, since a producer or publisher can invoke a virtually unlimited number of Players 10. Alternative implementations in which, for example, an unlimited number of Feeds 18 can be associated with each Player 10 are contemplated and are within the spirit and scope of the invention. Those of skill also will appreciate that sources for a Feed 18 can be the Producer him or herself or other Producers of content. The SPLASHCAST® system will go to market with the intent to foster virtually no barriers to massive adoption of the SPLASHCAST® Player. In order to facilitate this, the SPLASHCAST® Player, and its companion products for selecting and designing content, are free.

This is illustrated in FIG. 13, which shows in block diagram form three different monetization approaches including 1) Free Syndication, 2) Producer Pays for Promotion, and 3) Publisher Pays for Content, all but one of the three approaches economically linking Content from a Producer (on the left) with a particular Player subscription from a Publisher (on the right), thereby to provide monetary incentive and compensation as indicated by the broad arrows underneath approaches 2) and 3).

Unlike advertising-supported sites where monetization is derived from the population of the user base and its attractiveness to advertisers, SPLASHCAST® will monetize its Internet services by enabling premium content producers to charge publishers for use of their streams and premium content publishers to charge producers to expose and promote their Feeds.

Once there is adoption and popularity for the SPLASHCAST® Player, it is expected to see copyright owners of premium content making their content available to publishers to use for a fee. This kind of content can include anything from popular amateur videos, to independent music, to TV episodes, to commercial music videos. One possible business model reflects an average fee of $25 per 1,000 exposures (CPM). This is in line with similar fee structures used on the Internet.

Similarly, it is expected to see publishers that have popular sites, so-called premium publishers, getting paid by content producers to whom the exposure and promotion of their content is valued. Similarly, one possible business model assumes a fee structure where the average is also $25 CPM paid by the content producer. These valued publishers can include any kind of site that has built up a community of interest with substantial traffic.

In either case, SPLASHCAST® would enter into a revenue-sharing agreement with premium producers and with premium publishers. This business model might be based on a 50/50 split for fees flowing in both directions. Those of skill in the art will appreciate that the revenue split is subject to change, thereby to respond to market conditions once there is a sufficient amount of interest in producing and publishing premium content with SPLASHCAST®.

Compensation as among a producer, a publisher and SPLASHCAST® can also be automated. When a producer and a publisher reach agreement on subject matter, e.g. a Feed 18 or a Media Asset 24a, 24b or 24c, the party owing the compensation pays SPLASHCAST® based upon SPLASHCAST's log of viewings of each Feed 18, Item 20a, 20b, 20c, and Media Asset 24a, 24b, 24c. SPLASHCAST® takes its agreed percentage of the compensation and forwards the remaining agreed percentage, e.g. via PayPal™ or alternative suitable electronic or papered system, to the party owed under the compensation agreement. It will be understood that, under the two-way, end-to-end, producer-to-publisher Monetization Hierarchy or structure (refer briefly back to FIG. 12), a producer or a publisher or both can owe compensation under one agreement and be entitled to compensation under another. Either way, SPLASHCAST® secures its compensation for providing the Dynamic Media Player 10, server(s), rich-content production tool suite, syndicated distribution system and method, etc.

The invention enables copyright owners to secure, control, track, and even profit from the viral distribution of their media assets on the Internet. Those of skill will appreciate that alternative monetization and compensation schemes are contemplated. Thus, any suitable monetization or compensation scheme is deemed to be within the spirit and scope of the invention.

The invention thus empowers non-technical individuals to personalize and publish and syndicate all kinds of media content available on the web dynamically to any website. SPLASHCAST® represents an exciting and timely opportunity to exploit the massive growth in rich media by making it available for mere mortals to easily publish on their websites and social network pages. In pursuit of this vision, SPLASHCAST® has created a new model for monetization of rich-media assets. SPLASHCAST® enables owners of popular websites to sell rich-media real estate on their sites while providing owners of valuable media content with an additional distribution channel to augment revenues.

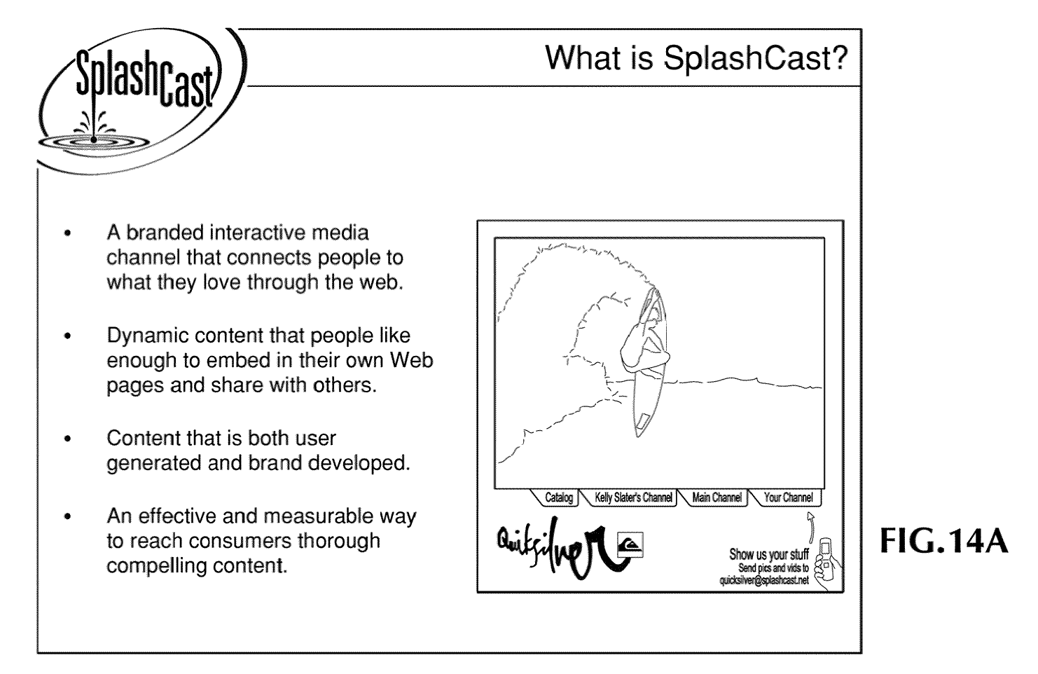

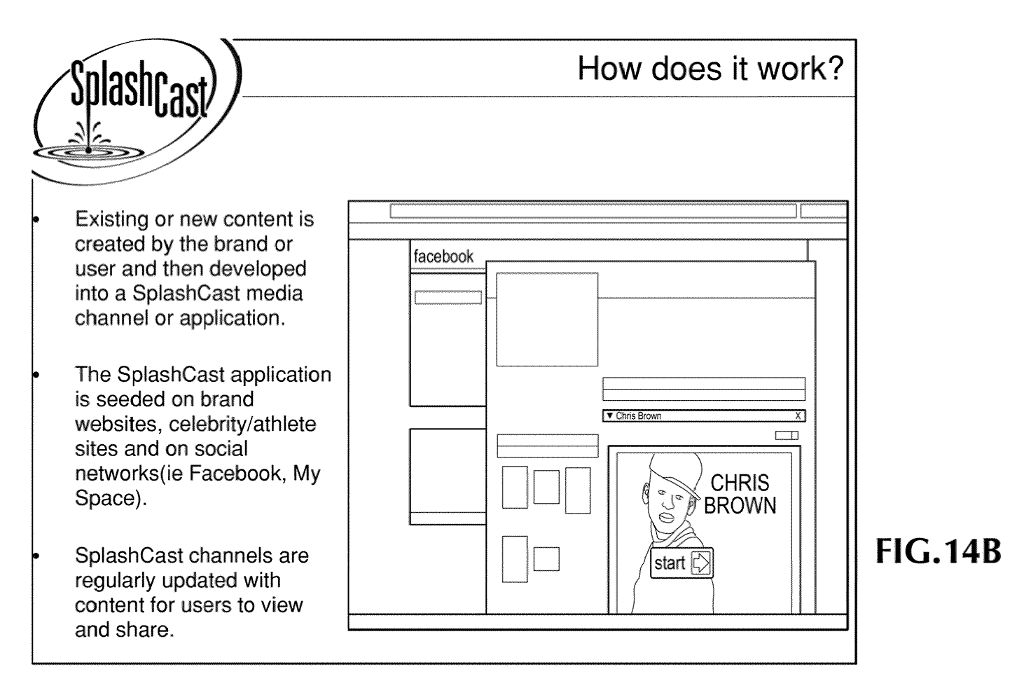

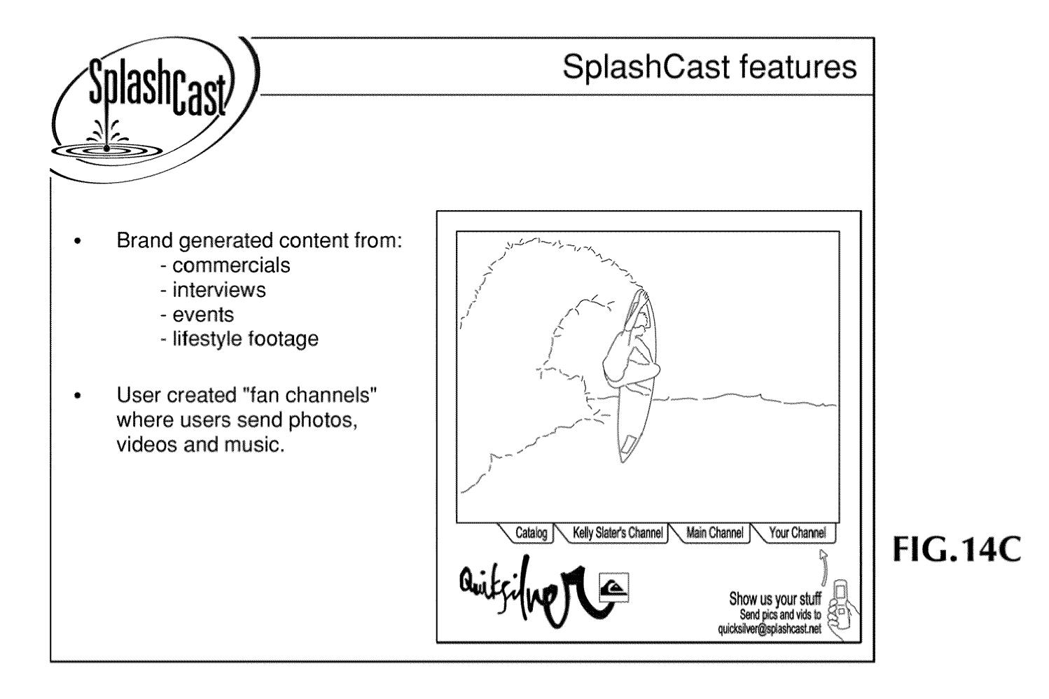

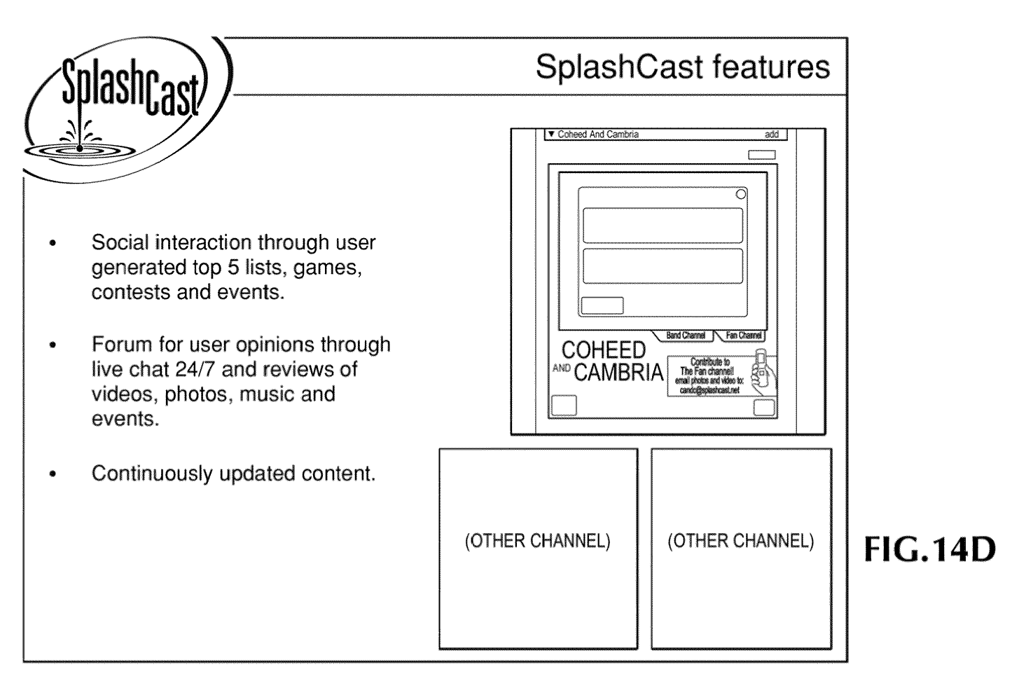

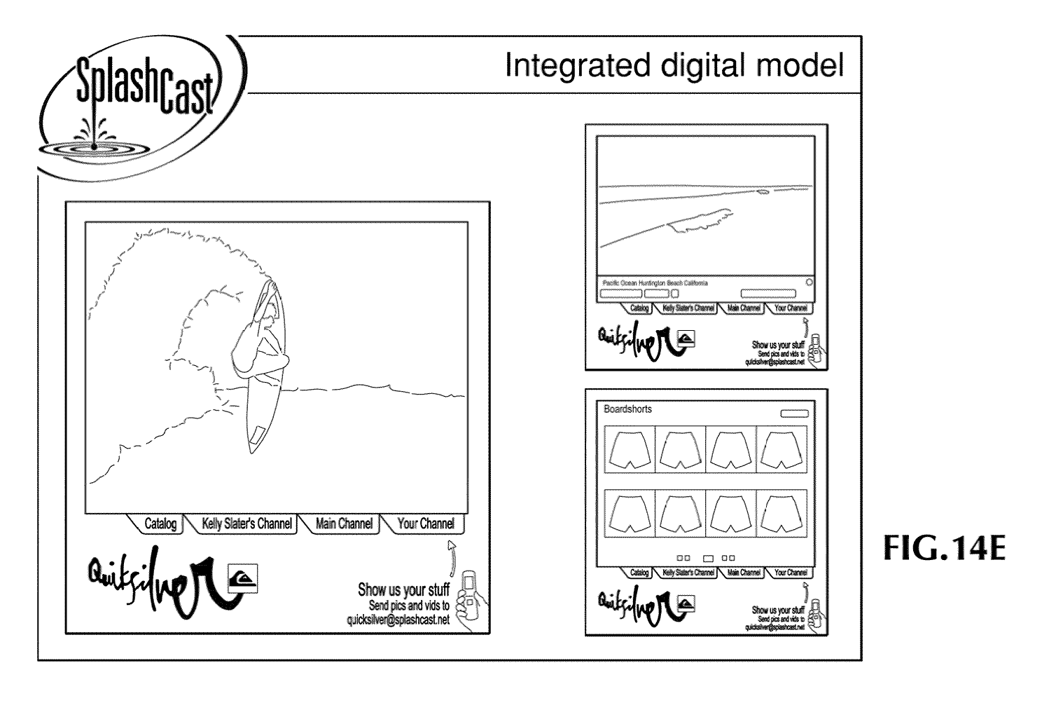

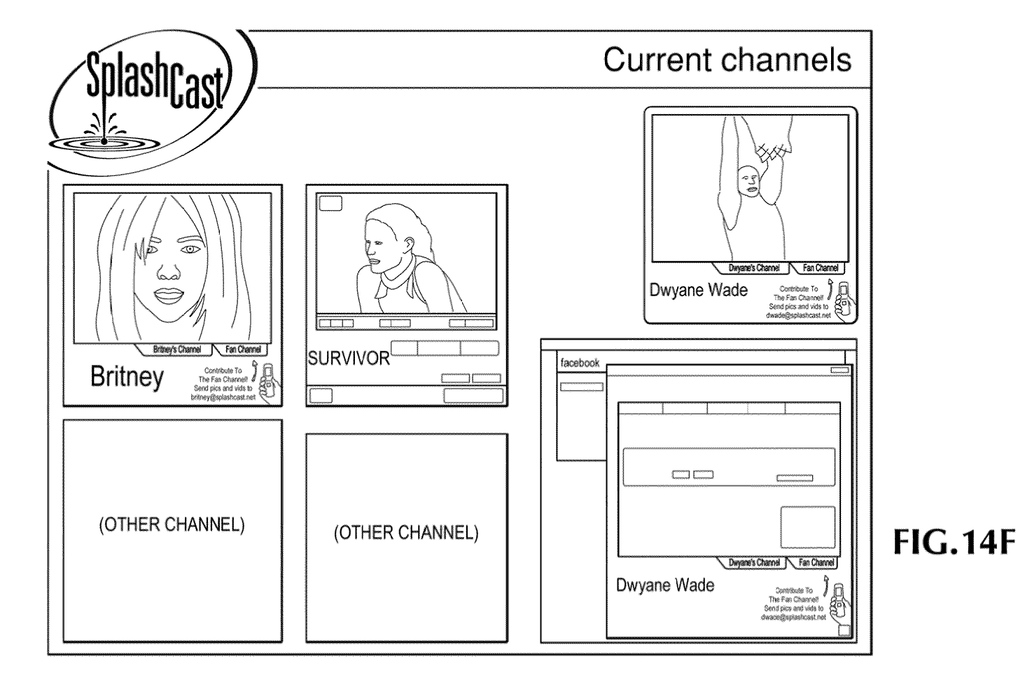

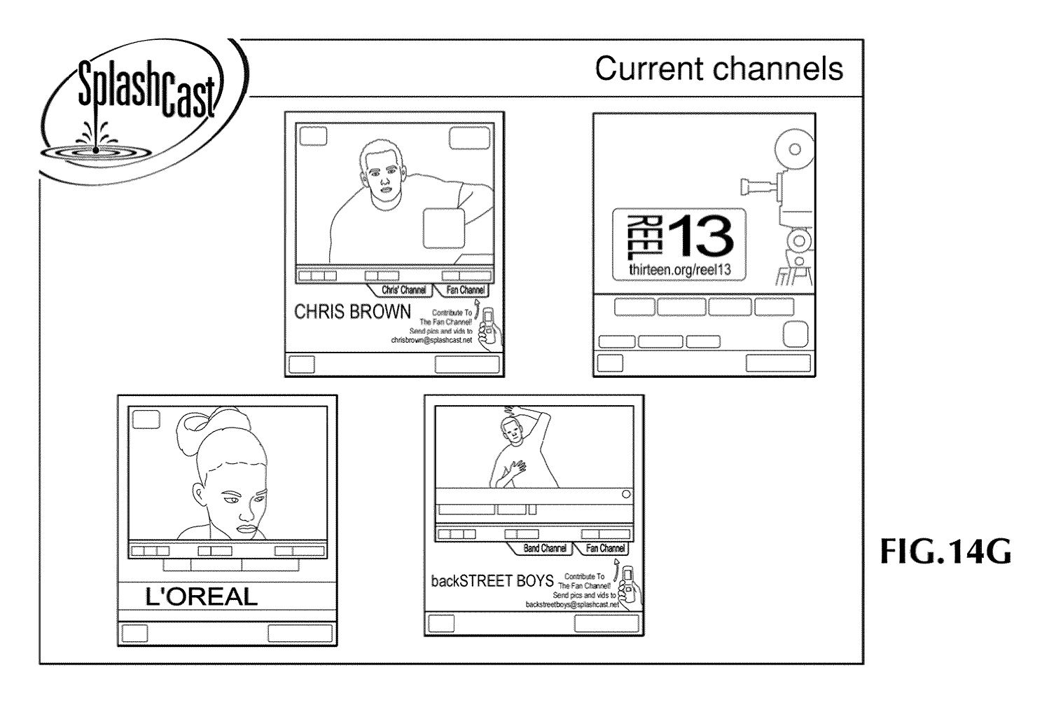

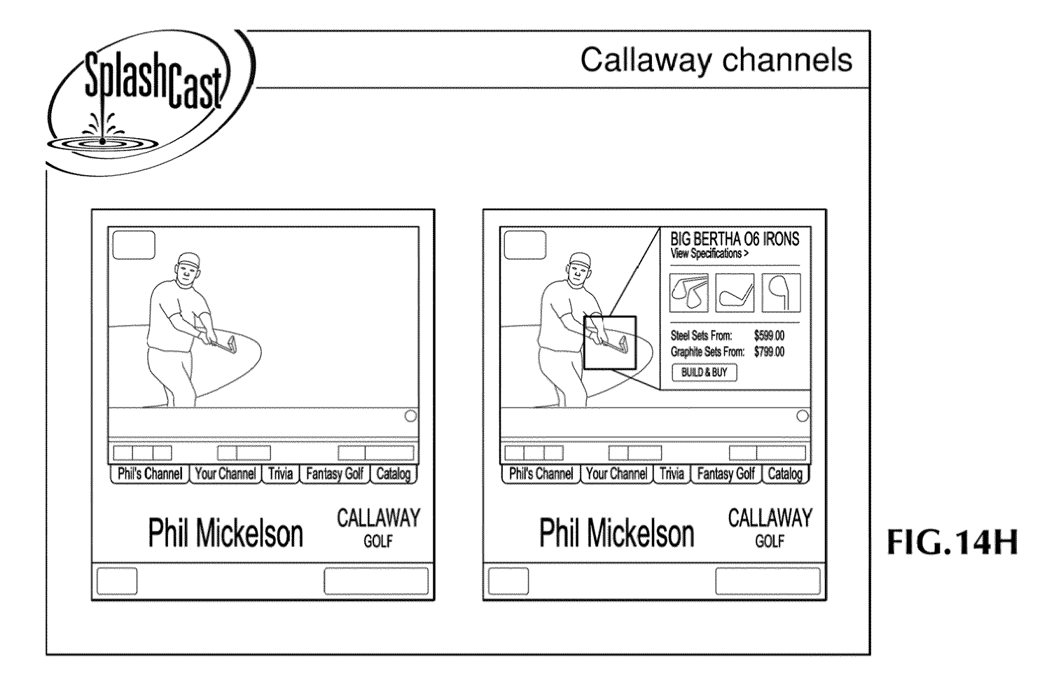

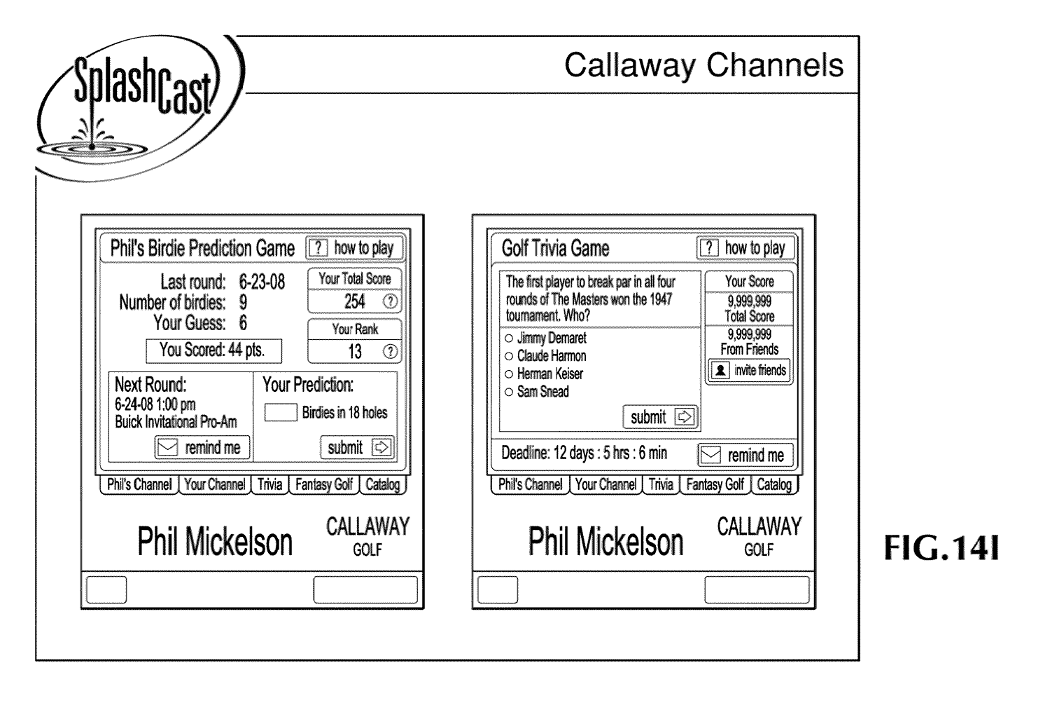

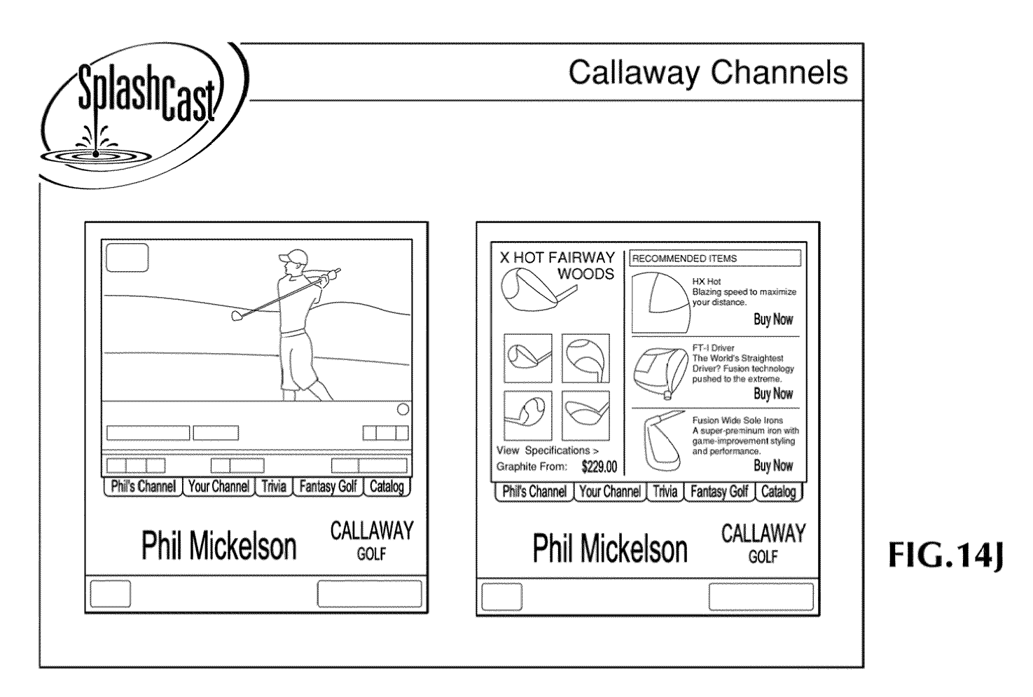

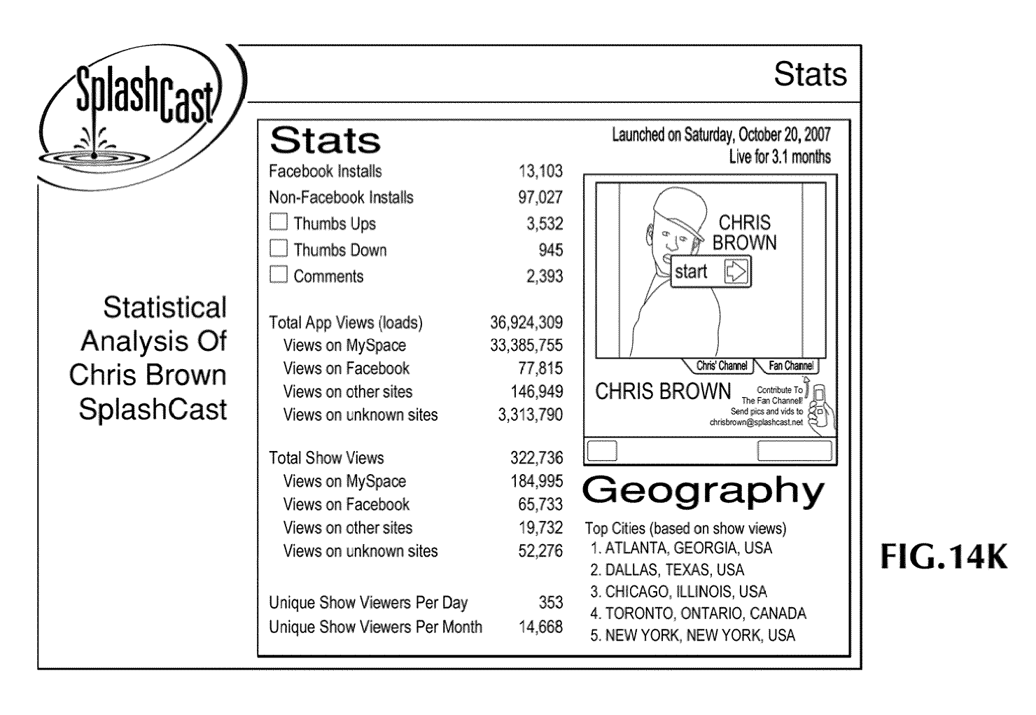

FIGS. 14A-14K illustrate another embodiment of the invention featuring a demographically-targeted rich media marketing system. FIGS. 14A-14K are believed to be largely self-explanatory from the brief description above and the discussion herein. It may be seen from FIGS. 14A-14K that in accordance with this embodiment of the invention by which rich-media players are branded or sponsored, high-quality and entertaining rich-media content with explicit or subtle branding blur the line between content and advertising in a manner that can increase product acceptance and brand adoption. Those of skill in the art will appreciate also that, by using the now-ubiquitous social networking concepts such as chat rooms, e-mail, text messaging, and others (including futures), users enjoy an entertaining, robust interaction with brands, sponsors, and friends to increase their brand loyalty and entertainment value.

In accordance with one feature of the invention, a user is given a reward incentive, e.g. points, discount coupons, free or add-on offers, or even merchandise for turning his or her friends onto a brand, e.g. by embedding a SPLASHCAST® player in his or her MySpace™, Facebook™ or other social networking page. If other users view the webpage and perhaps click-through the featured, branded rich-media player, the SPLASHCAST® system server can count such ‘hits’ and reward such promotional uses by the user. A formal system for rewards is contemplated whereby a user can also recruit others to do the same, thereby exponentially increasing the number of hits on a given branded rich-media player and virally affecting the brand's influence on consumers by strong, demographic, peer group loyalty.

The invention in this embodiment thus features:

1. The ability for consumers to create community around a brand via live chatting and contributing their own comments, videos and photos to a brand's SplashCast™ channel.
2. Three-way communication: from brand to consumers (broadcast), from consumers to consumers, and from consumers back to brand. This can provide invaluable insight on consumer behavior around a brand.
3. The backend content management system (CMS) that gives marketers the ability to update their network of SplashCast® players with new content, at any time, as often as they like.

Use Case:
Teen Lifestyle
More teenagers now (33 million) than any time since the baby boom generation.
Growth market with teens spending over $200 billion annually.
Teens want to connect with friends, carve out an identity an be creative.
Brands are increasingly a means for them to express their creativity and connect with friends.
The web is their primary media resource because it is informative, social and engaging.
Eighty-seven percent of teens are online and 35% of all teen media consumption is online.
Seventy percent of teenagers are active in social networks, spending and average of two hours a day.
The most engaging social networks are MySpace™ (120 million users) and Facebook™ (60 million users, projected to be 100 million by the end of 2008).
The Splashcast™ advantages include:
Video-driven for the ultimate user experience
Experiential and interactive
Permission-based model
Fuels creativity and self expression
Both user- and brand-developed content
Builds community within peer group of influence
Regularly updated content increases frequency of visits and time spent
High level of security and tractability
Limited development costs and usage-based fees

Those of skill in the art will appreciate that, while teenagers are the demographically targeted group of the above Use Case, other similarly affinitive and identifiable groups similarly can be targeted, e.g. baby boomers, retirees, professionals, laborers, etc.

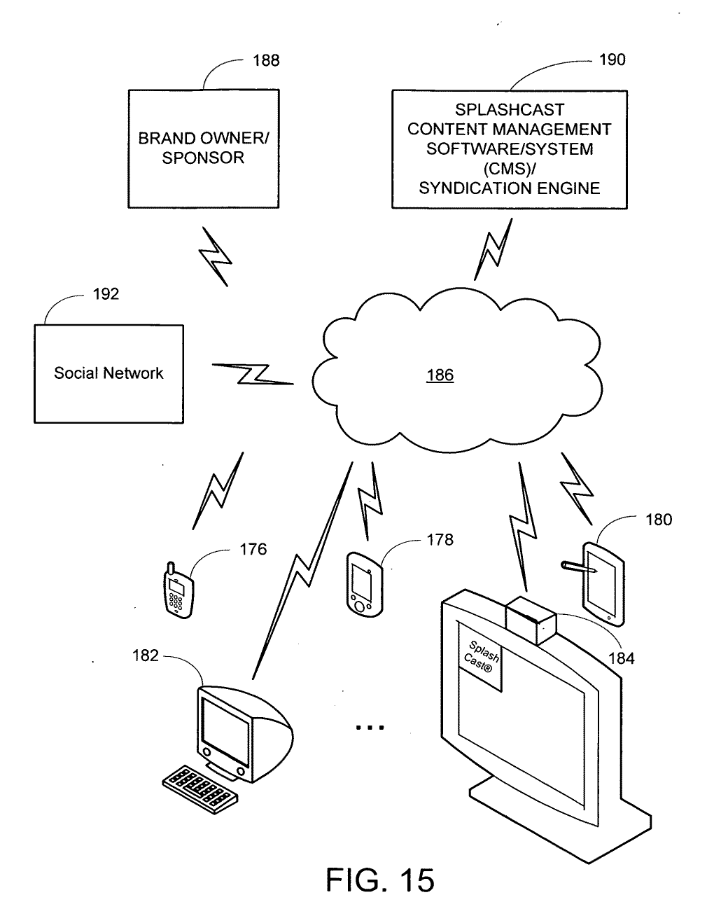

FIG. 15 illustrates yet another embodiment of the invention featuring a rich-media content management software/system (CMS) (also referred to herein as a syndication engine) and demographically-targeted branded/sponsored consumer interaction. FIG. 15 shows various user nodes 176, 178, 180, 182, . . . 184 whose users are interactively coupled together via the Internet 186. Those of skill in the art will appreciate that user nodes 176, 178, 180, 182, . . . 184 can be any suitable user device such as a personal digital assistant (PDA)-inclusive device such as an iPhone G3, BlackBerry mobile phone or the like; a PDA; a notebook computer; a desktop computer; a TV set-top adapter capable of presenting a computer window (whether smaller than or co-extensive with the display area) on the television screen along with other applications including television broadcast content; and the like.

Notably, the user nodes or devices need not include browsers, but may instead provide more dedicated SPLASHCAST® feeds as taught herein that enable a user to explore and enjoy content and branding alone or in a social network environment with friends, family or mere acquaintances. Also operatively coupled to the Internet 186 are (one or more of) brand owners or sponsors such as brand owner 188 and SPLASHCAST's own CMS 190, and, optionally, one or more social networks 192 such as MySpace™, FaceBook™ or the like. Those of skill in the art will appreciate that one or more of user nodes or devices 176, 178, 180, 182, . . . 184 (preferably having such stand-alone application capability as do the iPhone G3 and the BlackBerry mobile phones) typically might include one or more of an Internet connection, a web browser, and a social network-facilitated webpage providing chat rooms, text messaging, etc. Any and all such user node applications are contemplated as being within the spirit and scope of the present invention.

In accordance with the invention, such a webpage might also have a SPLASHCAST® branded rich-media player 10′ (shown in dashed lines), as described and illustrated hereinabove. Those of skill in the art will appreciate that one or more of the sponsor, SPLASHCAST® itself and computer users are capable of designing (producing), broadcasting and viewing rich-media channels containing both branding/sponsoring information as described herein and high-quality content whether it be audio, visual, text, other or a combination. Original rich-media content thus can go from SPLASHCAST® to a brand owner/sponsor under a development agreement therebetween, from a brand owner/sponsor to a user (as a consumer), from a user (as a producer) to a brand owner/sponsor (as a submission), or among users (as social networking or peer-group affiliates, e.g. family and friends).

A rich interaction can ensue among multiple parties, whether it involves simply experiencing rich-media content, creatively advertising product in a less invasive way than with conventional pop-ups or spams, playing a game or answering trivia questions and comparing answers with one's friends, chatting about what is being experienced, or shopping from an on-line catalogue affiliated with the brand owner or sponsor. All this is made possible by provision of the SPLASHCAST® platform described in great detail herein and a ‘skinned’ or branded version of the rich-media player.

Those of skill in the art will appreciate that the software architecture described and illustrated herein can be implemented in any suitable code by the use of any suitable coding and language tools. For example, C#, XML, Flash Actionscript, and SQL are a suitable suite of tools for coding the invented system software.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. An Internet-based content distribution system comprising:
a content management system (CMS) including a console and a library of plural contents, the CMS being configured dynamically to update the plural contents, and
a content feed mechanism operatively coupled with the CMS, the content feed mechanism enabling the delivery of the dynamically updated plural contents into syndicated publication at one or more syndicated user nodes,
wherein the content is managed at the console to cause the feed mechanism to update the contents in real time at each of the one or more syndicated user nodes.

2. The system of claim 1, wherein one or more of the user nodes includes one or more of a cell phone, a personal digital assistant (PDA), a notebook computer, a desktop computer, and a television set-top computer adapter or the like.

3. The system of claim 2, wherein one or more of the user nodes is mobile.

4. The system of claim 3, wherein one or more of the user nodes is portable and battery operated.

5. The system of claim 4, wherein by publishing the content once, all user nodes receive the distributed content.

6. The system of claim 5, wherein the content feed mechanism is Internet-based.

7. The system of claim 6, wherein the plural contents includes one or more of dynamic or static images, dynamic video or audio, text, HTML, mixed media presentation, Microsoft PowerPoint slides, and Adobe PDF pages.

8. The system of claim 7, wherein the content feed mechanism includes a rich-media player viewable at each user node.

9. The system of claim 8, wherein the CMS is operatively coupled with a proprietary server.

10. The system of claim 9, wherein the CMS is operatively coupled with a third-party server such as YouTube, FlickR or the like.

11. The system of claim 10 further comprising:
one or more Internet-based rich-media content players capable of being embedded within websites and enabling a user to view or listen to rich-media contents collectively linked thereto by the CMS and content feed mechanism on the one or more syndicated user nodes.

12. A demographically-targeted branded rich-media content marketing method comprising:
providing a rich-media content player within a viewable window that identifies an owner of a brand;
broadcasting the window over the Internet;
collecting revenue from the owner based at least in part upon the number of viewings of the window.

13. The method of claim 12 further comprising, prior to the providing:
designing the window to specifications provided by the brand owner.

14. The method of claim 13, wherein the specification demographically targets particular populations of viewers by specifying predefined content and look-and-feel.

15. The method of claim 12, wherein the broadcasting includes broadcasting over one or more existing demographically-targeted social networks.

16. The method of claim 12, wherein the broadcasting includes embedding a rich-media player within one or more web pages.

17. The method of claim 12, wherein the rich-media content can be updated in real time.

18. The method of claim 17, wherein the third-party brand is persistently visible to the viewers.

19. The method of claim 17, wherein the third-party brand is not persistently visible to the viewers.

20. The method of claim 17 which further comprises:
providing an incentive-reward system for users who engage other users in viewing the content.

21. The method of claim 12 which further comprises:
providing an Internet-based forum for interactive game-playing by users of the content.

22. The method of claim 12 further comprising:
providing an Internet-based forum for plural users of the content interactively and in real time to engage in one or more of chatting about, opining about, reviewing, critiquing, ranking and endorsing the content.

23. The method of claim 12 further comprising:
promoting a third-party brand within the branded content.

24. The system of claim 12, wherein the brand and content are highly integrated, thereby blurring a line between branding and content.

25. The system of claim 12, wherein the content itself includes one or more banner ads.
